(19) United States
(12) Patent Application Publication
(10) Pub. No.: US 2025/0377505 A1
(43) Pub. Date: Dec. 11, 2025

(54) LOCKABLE FIBER OPTIC CONNECTOR ASSEMBLY

(71) Applicant: Senko Advanced Components, Inc., Hudson, MA (US)

(72) Inventors: Shota MIZUKI, Tokyo (JP); Kazuyoshi TAKANO, Tokyo (JP); Man Kit Joe WONG, Kowloon (HK); Man Ming HO, Kowloon (HK)

(21) Appl. No.: 19/229,871

(22) Filed: Jun. 5, 2025

Related U.S. Application Data
(60) Provisional application No. 63/657,497, filed on Jun. 7, 2024.
(60) Provisional application No. 63/661,562, filed on Jun. 18, 2024.

(51) Int. Cl. G02B 6/38

(52) U.S. Cl. CPC G02B 6/3825; G02B 6/3874; G02B 6/3885; G02B 6/3893

(57) ABSTRACT

A lockable fiber optic connector assembly includes an MPO connector and a lock that is removably installable on the MPO connector at a locking position when the MPO connector is mated with the MPO adapter. The lock has forward and rearward facing locking surfaces. The forward facing locking surface opposes a rearward facing surface of the MPO outer release sleeve and the rearward facing locking surface simultaneously opposes a forward facing surface of the flange of the MPO inner housing when the lock is installed. The rearward facing surface will engage the forward facing locking surface and the forward facing surface will engage the rearward facing locking surface to block the outer release sleeve from releasing the MPO connector from the MPO adapter.

### CROSS REFERENCE TO RELATED APPLICATION

This application claims priority to U.S. Provisional Patent Application No. 63/657,497 and to U.S. Provisional Patent Application No. 63/661,562, each of which is hereby incorporated by reference in its entirety.

### FIELD

This disclosure generally pertains to a lockable fiber optic connector assembly.

### BACKGROUND

Fiber optic connectors are widely used in high-speed communication and data networks. The inventors have recognized a need for ways to better secure fiber optic connectors in their mating adapters, especially in high connection density network environments, to prevent inadvertent or authorized extraction of the connectors after they are plugged in.

### SUMMARY

In one aspect, a lockable fiber optic connector assembly comprises an MPO connector configured to mate with an MPO adapter. The MPO connector comprises a multifiber ferrule, an inner housing, and an outer release sleeve. The MPO connector has a longitudinal axis. The inner housing has a front end portion and a rear end portion spaced apart along the longitudinal axis. The inner housing comprises a flange at the rear end portion. The flange defines a forward facing surface. The outer release sleeve has a rearward facing surface. The outer release sleeve is movable in relation to the inner housing between a front position and a rear position. The outer release sleeve is configured to secure the MPO connector in mated relationship with the MPO adapter when the outer release sleeve is in the front position and configured to release the MPO connector from the MPO adapter when the outer release sleeve is moved from the front position toward the rear position. A lock is configured to be removably installed on the MPO connector at a locking position when the MPO connector is mated with the MPO adapter and the outer release sleeve is in the front position. The lock comprises a forward facing locking surface and a rearward facing locking surface. The forward facing locking surface is shaped and arranged to oppose the rearward facing surface of the outer release sleeve, and the rearward facing locking surface is shaped and arranged to simultaneously oppose the forward facing surface of the flange of the inner housing when the lock is installed at the locking position such that the lock is configured so that the rearward facing surface of the outer release sleeve will engage the forward facing locking surface and the forward facing surface of the flange will engage the rearward facing locking surface to block the outer release sleeve from moving from the front position toward the rear position to release the MPO connector from the MPO adapter, whereby the lock locks the MPO connector in the MPO adapter when the lock is installed at the locking position.

In another aspect, a method of making a secure optical connection comprises plugging an MPO connector into an MPO adapter. after plugging the MPO connector into the MPO adapter, a lock is installed on the MPO connector so that the lock simultaneously opposes a rearward facing surface of an outer release sleeve and a forward facing surface on an inner housing to prevent extraction of the MPO connector from the MPO adapter by rearward displacement of the outer release sleeve in relation to the inner housing.

Other aspects will be in part apparent and in part pointed out hereinafter.

### BRIEF DESCRIPTION OF THE DRAWINGS

FIG. 1 is plan view of a conventional MPO connector;

FIG. 2 is an elevation of the MPO connector;

FIG. 3 is a perspective of the MPO connector;

FIG. 4 is another elevation of the MPO connector;

FIG. 5 is an exploded perspective of a lockable fiber optic connector assembly in accordance with the present disclosure;

FIG. 6 is a perspective of the lockable fiber optic connector assembly showing a lock separated from the MPO connector thereof;

FIG. 7 is a perspective of the lockable fiber optic connector assembly;

FIG. 8 is another perspective of the lockable fiber optic connector assembly;

FIG. 9 is a plan view of the lockable fiber optic connector assembly;

FIG. 10 is an elevation of the lockable fiber optic connector assembly

FIG. 12 is a perspective of the lock;

FIG. 13 is a plan view of the lock;

FIG. 14 is an elevation of the lock;

FIG. 15 is another elevation of the lock;

FIG. 16 is a cross section of the lockable fiber optic connector assembly;

FIG. 17 is another cross section of the lockable fiber optic connector assembly;

FIG. 18 is an exploded perspective of another embodiment of a lockable fiber optic connector assembly;

FIG. 19 is a perspective showing a lock of the lockable fiber optic connector assembly of FIG. 18 separated from an MPO connector;

FIG. 20 is a perspective of a lock of FIG. 19;

FIG. 21 is a plan view of the lock of FIG. 19;

FIG. 22 is an elevation of the lock of FIG. 19;

FIG. 23 is another elevation of the lock of FIG. 19;

FIG. 24 is another perspective of the lock of FIG. 19;

FIG. 25 is a perspective of the lockable fiber optic connector assembly of FIG. 18;

FIG. 26 is another perspective of the lockable fiber optic connector assembly of FIG. 18;

FIG. 27 is an elevation of the lockable fiber optic connector assembly of FIG. 18;

FIG. 28 is a plan view of the lockable fiber optic connector assembly of FIG. 18;

FIG. 29 is another elevation of the lockable fiber optic connector assembly of FIG. 18;

FIG. 30 is a cross section of the lockable fiber optic connector assembly of FIG. 18;

FIG. 31 is another cross section of the lockable fiber optic connector assembly of FIG. 18;

FIG. 32 is an exploded perspective of another embodiment of a lockable fiber optic connector assembly;

FIG. 33 is a perspective showing a lock of the lockable fiber optic connector assembly of FIG. 32 separated from an MPO connector;

FIG. 34 is a perspective of the lock of FIG. 33;

FIG. 35 is a plan view of the lock of FIG. 33;

FIG. 36 is an elevation of the lock of FIG. 33;

FIG. 37 is another elevation of the lock of FIG. 33;

FIG. 38 is a perspective of the lockable fiber optic connector assembly of FIG. 32;

FIG. 39 is a plan view of the lockable fiber optic connector assembly of FIG. 32;

FIG. 40 is an elevation of the lockable fiber optic connector assembly of FIG. 32;

FIG. 41 is another elevation of the lockable fiber optic connector assembly of FIG. 32;

FIG. 42 is a cross section of the lockable fiber optic connector assembly of FIG. 32;

FIG. 43 is another cross section of the lockable fiber optic connector assembly of FIG. 32;

FIG. 44 is a perspective of another embodiment of a lockable fiber optic connector assembly showing a lock separated from an MPO connector;

FIG. 45 is an elevation of the scene in FIG. 44;

FIG. 46 is another elevation of the scene in FIG. 44;

FIG. 47 is a perspective of a lock portion of the lock of FIG. 44 of the lockable fiber optic connector assembly of FIG. 44;

FIG. 48 is another perspective of the lock portion of the lock of FIG. 44;

FIG. 49 is an elevation of the lock portion of the lock of FIG. 44;

FIG. 50 is another elevation of the lock portion of the lock of FIG. 44;

FIG. 51 is another elevation of the lock portion of the lock of FIG. 44;

FIG. 52 is a perspective of the lock of FIG. 44;

FIG. 53 is a perspective of the lockable fiber optic connector assembly of FIG. 44;

FIG. 54 is a magnified perspective of a portion of the lockable fiber optic connector assembly of FIG. 44;

FIG. 55 is an elevation of the lockable fiber optic connector assembly of FIG. 44;

FIG. 56 is a plan view of the lockable fiber optic connector assembly of FIG. 44;

FIG. 57 is another elevation of the lockable fiber optic connector assembly of FIG. 44;

FIG. 58 is another elevation of the lockable fiber optic connector assembly of FIG. 44;

FIG. 59 is a perspective of another embodiment of a lockable fiber optic connector assembly showing a lock thereof separated from an MPO connector;

FIG. 60 is an elevation of the scene in FIG. 59;

FIG. 61 is a plan view of the scene in FIG. 59;

FIG. 62 is an exploded perspective of the lock of FIG. 59;

FIG. 63 is a perspective of the lock of FIG. 59;

FIG. 64 is a plan view of a lock portion of the lock of FIG. 59;

FIG. 65 is an elevation of the lock portion of the lock of FIG. 59;

FIG. 66 is a perspective of the lockable fiber optic connector assembly of FIG. 59;

FIG. 67 is another perspective of the lockable fiber optic connector assembly of FIG. 59;

FIG. 68 is a plan view of the lockable fiber optic connector assembly of FIG. 59;

FIG. 69 is an elevation of the lockable fiber optic connector assembly of FIG. 59;

FIG. 70 is another elevation of the lockable fiber optic connector assembly of FIG. 59;

FIG. 71 is a perspective of another embodiment of a lockable fiber optic connector assembly showing a lock thereof separated from an MPO connector;

FIG. 72 is an elevation of the scene in FIG. 71;

FIG. 73 is another elevation of the scene in FIG. 71;

FIG. 74 is an exploded perspective of the lock of FIG. 71;

FIG. 75 is a perspective of the lock of FIG. 71;

FIG. 76 is a plan view of a lock portion of the lock of FIG. 71;

FIG. 77 is an elevation of the lock portion of the lock of FIG. 71;

FIG. 78 is another elevation of the lock portion of the lock of FIG. 71;

FIG. 79 is another elevation of the lock portion of the lock of FIG. 71;

FIG. 80 is a perspective of the lockable fiber optic connector assembly of FIG. 71;

FIG. 81 is a plan view of the lockable fiber optic connector assembly of FIG. 71;

FIG. 82 is an elevation of the lockable fiber optic connector assembly of FIG. 71;

FIG. 83 is a perspective of the lockable fiber optic connector assembly of FIG. 71;

FIG. 84 is a perspective of another embodiment of a lockable fiber optic connector assembly showing lock thereof separated from an MPO connector;

FIG. 85 is a perspective of the lock of FIG. 85;

FIG. 86 is a perspective of the lockable fiber optic connector assembly of FIG. 84;

FIG. 87 is a perspective of a push-pull boot MPO connector;

FIG. 88 is a plan view of the push-pull boot MPO connector;

FIG. 89 is an elevation of the push-pull boot MPO connector;

FIG. 90 is another elevation of the push-pull boot MPO connector;

FIG. 91 is a perspective of a lockable fiber optic connector assembly including two push-pull boot MPO connectors and a lock therefor separated from the push-pull boot MPO connectors;

FIG. 92 is a perspective of the lock of FIG. 91;

FIG. 93 is a plan view of the lock of FIG. 91;

FIG. 94 is an elevation of the lock of FIG. 91;

FIG. 95 is another elevation of the lock of FIG. 91;

FIG. 96 is a perspective of the lockable fiber optic connector assembly of FIG. 91;

FIG. 97 is a plan view of the lockable fiber optic connector assembly of FIG. 91;

FIG. 98 is an elevation of the lockable fiber optic connector assembly of FIG. 91;

FIG. 99 is another elevation of the lockable fiber optic connector assembly of FIG. 91;

FIG. 100 is a cross section of the lockable fiber optic connector assembly of FIG. 91;

FIG. 101 is a flow diagram showing by way of illustrations a method of using the lockable fiber optic connector assembly of FIG. 91.

Corresponding parts are given corresponding reference characters throughout the drawings.

### DETAILED DESCRIPTION

As will be explained in further detail below, this disclosure generally pertains to various embodiments of lockable fiber optic connector assemblies. Lockable fiber optic connector assemblies in accordance with the present disclosure broadly comprise a push-pull fiber optic connector and a lock configured to be removably installed on the push-pull fiber optic connector at a locking position in which the lock blocks the connector's pullback release element from being pulled back in relation to the connector's inner housing in the usual way to release the push-pull connector from a mating adapter. In every illustrated embodiment, the lockable fiber optic connector assembly is an MPO connector. But it will be understood that the lockable fiber optic connector assembly could be another type of push-pull fiber optic connector without departing from the scope of the disclosure.

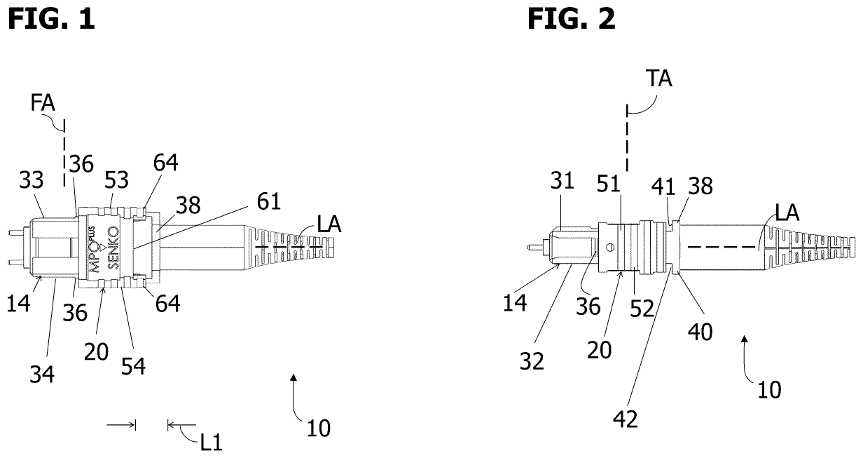

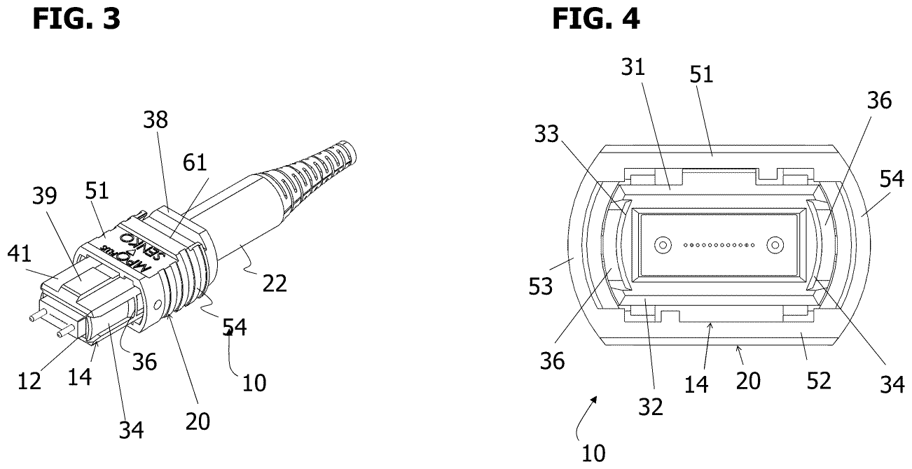

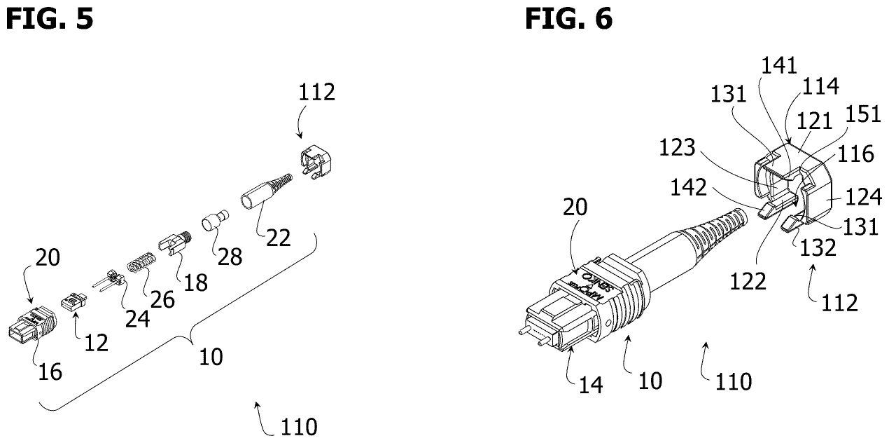

Before describing a number of example embodiments of suitable locks for MPO connectors, this disclosure will briefly describe certain features of conventional MPO connectors, an example of which is generally indicated at reference number 10 in FIGS. 1-4. The MPO connector 10 is broadly configured to mate with a compatible MPO adapter. The MPO connector 10 has a longitudinal axis LA, a fiber alignment axis FA perpendicular to the longitudinal axis, and a transverse axis TA perpendicular to both the longitudinal axis and the fiber alignment axis. The MPO connector 10 generally comprises a multifiber ferrule 12, an inner housing 14, and an outer release sleeve 20. The inner housing 14 is made up of a plug frame 16 and a back body 18 (see FIG. 5). The illustrated MPO connector 10 also comprises a cable boot 22 secured to the rear end portion of the inner housing 14, as well as the conventional guide pin holder 24, ferrule spring 26, and crimp body 28 depicted in FIG. 5.

As will be explained in further detail below, the various embodiments of MPO connector locks described herein are configured to lock MPO connectors 10 in MPO adapters when they are installed at respective locking positions. At each locking position, certain locking surfaces of the respective lock simultaneously oppose a forward facing surface defined of the inner housing 14 and rearward facing surface of the outer release sleeve 20. Throughout this description, the relevant surfaces are described as “forward facing” or “rearward facing.” These terms refer to the general orientation of the surface or surface portion along the longitudinal axis of the MPO connector 10. A “forward facing surface” faces the mating end of the MPO connector 10 (e.g., toward the MPO adapter during plug-in), and a “rearward facing surface” is generally oriented away from the mating end, typically toward the cable boot 22. Such surfaces, or portions thereof, can exist at various locations on inner housing 14 and outer release sleeve 20, and any surface portion that faces the proper direction may form the “forward facing surface” or “rearward facing surface” at issue in this disclosure. Example surface portions that can suitably be used as one part or the entirety of the relevant “forward facing surface” or “rearward facing surface” will be described below. But it will be understood that “forward facing surface” and “rearward facing surface” are not limited to the specific surface portions called out herein.

The inner housing 14 of the MPO connector 10 has a front end portion and a rear end portion spaced apart along the longitudinal axis LA. The inner housing 14 has a first housing broad side 31 and an opposite second housing broad side 32. The housing broad sides 31, 32 are spaced apart along the transverse axis TA. As is known to those skilled in the art, a polarity key 39 is formed on one of the housing broad sides 31, 32. Perpendicular to the first and second housing broad sides 31, 32, the inner housing 14 comprises a third housing latching side 33 and a fourth housing latching side 34 opposite the third housing latching side. The housing latching sides 38, 40 are spaced apart along the fiber alignment axis FA. As is known to those skilled in the art, the third and fourth housing latching sides 33, 34 comprise latch detents 36 that are configured for latching engagement with adapter latch arms (not shown) of a mating MPO adapter.

The inner housing 14 further comprises a flange 38, 40 at its rear end portion. More specifically, the inner housing 14 comprises a first flange portion 38 on the first housing broad side 31 and a second flange portion 40 on the second housing broad side 32. The first flange portion 38 defines a first forward facing surface portion 41, and the second flange portion 40 defines a second forward facing surface portion 42. As will be explained in further detail below, various embodiments of lockable fiber optic connector assemblies in accordance with the present disclosure use one or both of the forward facing surface portions 41, 42 as the structure that braces the lock so that the lock resists pullback of the outer release sleeve 20 for extraction of the MPO connector 10 from a mating adapter.

The outer release sleeve 20 is arranged around the inner housing 14. The outer release sleeve 20 comprises a first sleeve broad side 51 and an opposite second sleeve broad side 52, which are positioned outboard of the first housing broad side 31 and the second housing broad side 32, respectively. The outer release sleeve 20 also includes a third latch covering side 53 and an opposite fourth latch covering side 54 positioned outboard of the third housing latching side 33 and the fourth housing latching side 34, respectively. As is known to those skilled in the art, the outer release sleeve 20 is movable in relation to the inner housing 14 between a front position and a rear position. When the MPO connector 10 is mated to an adapter and the outer release sleeve 20 is in the front position, the third and fourth latch covering sides 53, 54 cover the adapter latch arms (not shown) latched with the third and fourth latching sides 33, 34, which prevents the adapter latch arms from spreading and unlatching from the latch detents 36. When the outer release sleeve 20 is pulled back relative to the inner housing from the front position toward the rear position, the third and fourth latch covering sides 53, 54 uncover the adapter latch arms, which permits the adapter latch arms to spread and unlatch from the latch detents 36, thereby releasing the MPO connector from the adapter for extraction.

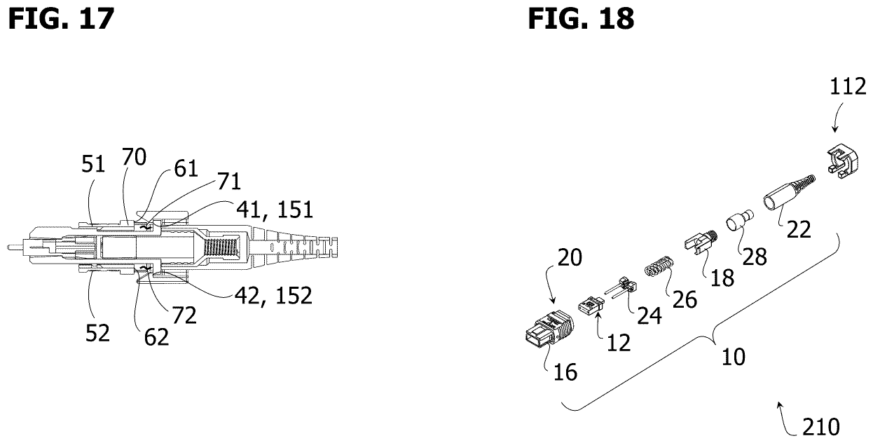

As can be seen, the outer release sleeve 20 has various rearward facing surface portions, any one or more of which can form the rearward facing surface that opposes a forward facing locking surface of a lock to prevent pullback of the outer release sleeve 20. For example, one rearward facing surface portion 61 is defined by the first sleeve broad side 51, another rearward facing surface portion 62 (FIG. 17) is defined by the second sleeve broad side 52, still another rearward facing surface portion 63 is defined by the third latch covering side 53, and yet another rearward facing surface portion 64 is defined by the fourth latch covering side 54. Any one or more of the rearward surface portions 61, 62, 63, 64 can provide the operative engagement with a lock to secure the MPO connector 10 in an adapter and prevent its extraction.

The MPO connector 10 is shaped and arranged such that a first gap 71 is defined between the first forward facing surface portion 41 and the first rearward facing surface portion 61. The MPO connector 10 is also shaped and arranged such that a second gap 72 (FIG. 17) is defined between the second forward facing surface portion 42 and the second rearward facing surface portion 62. Each gap 71, 72 extends along the longitudinal axis from the respective forward facing surface portion 41, 42 to the respective rearward facing surface portion 61, 62. The gaps 71, 72 exist when the outer release sleeve 20 is in the front position and provide clearance for the outer release sleeve to move rearward to the rear position. When the outer release sleeve 20 is in the front position, each gap 71, 72 has a length L1 along the longitudinal axis from the respective forward facing surface portion 41, 42 to the respective rearward facing surface portion 61, 62.

As shown in FIG. 17, the MPO connector 10 also has an interface opening 70 at the rear end portion of the outer release sleeve 20. The interface opening 70 extends along the transverse axis TA from the first housing broad side 31 to the first sleeve broad side 51.

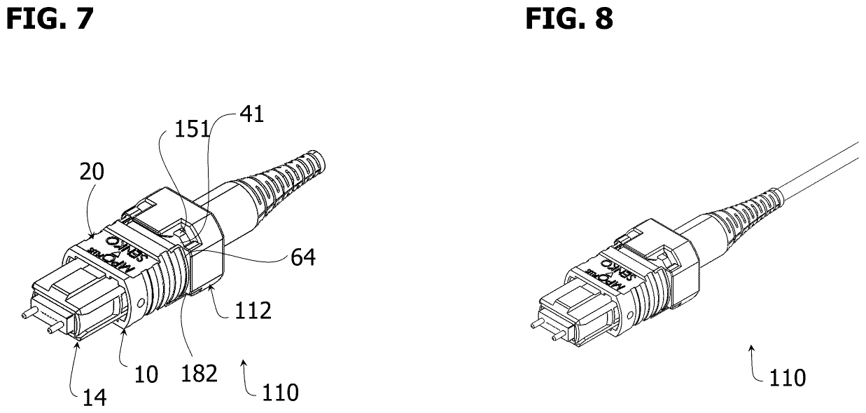

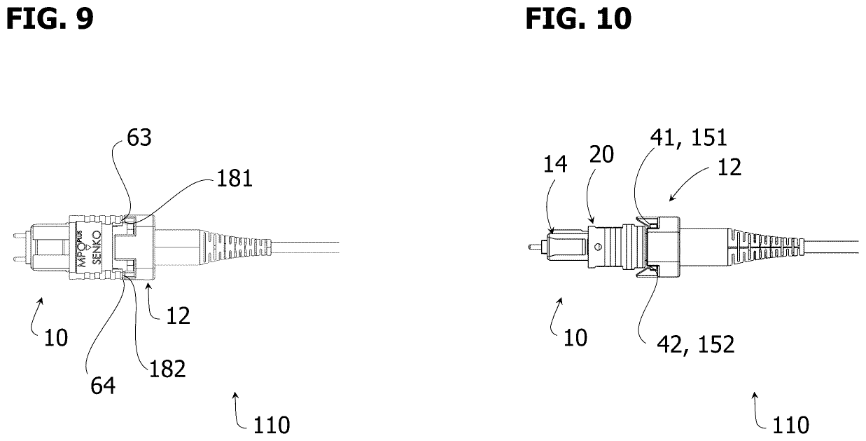

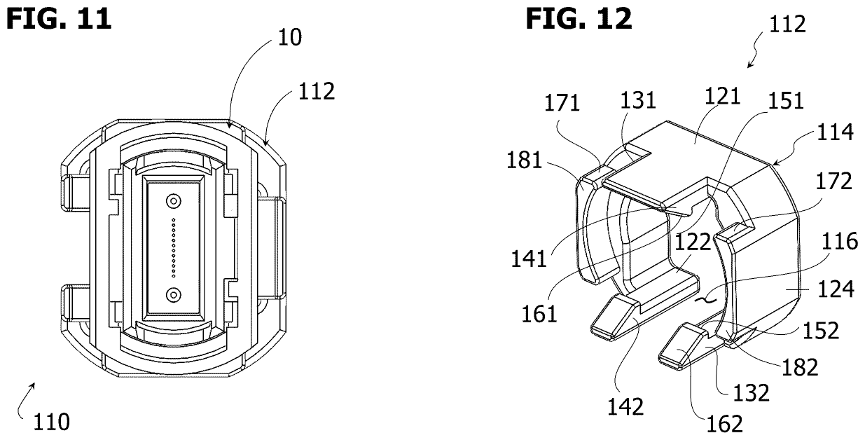

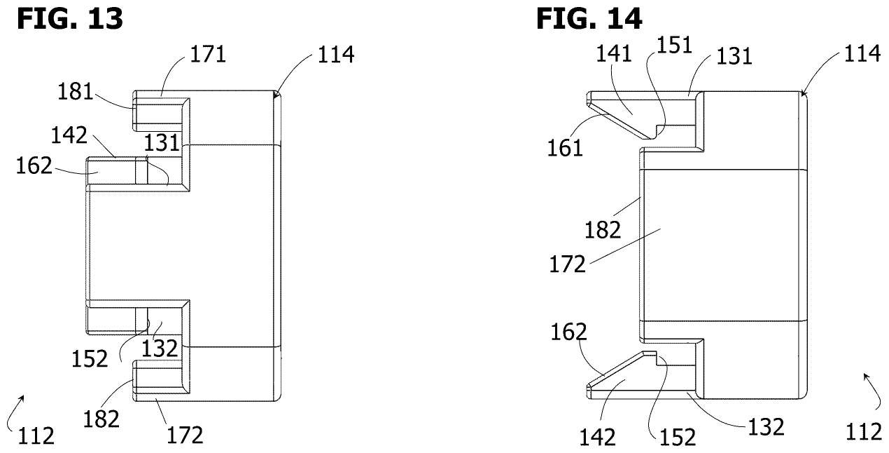

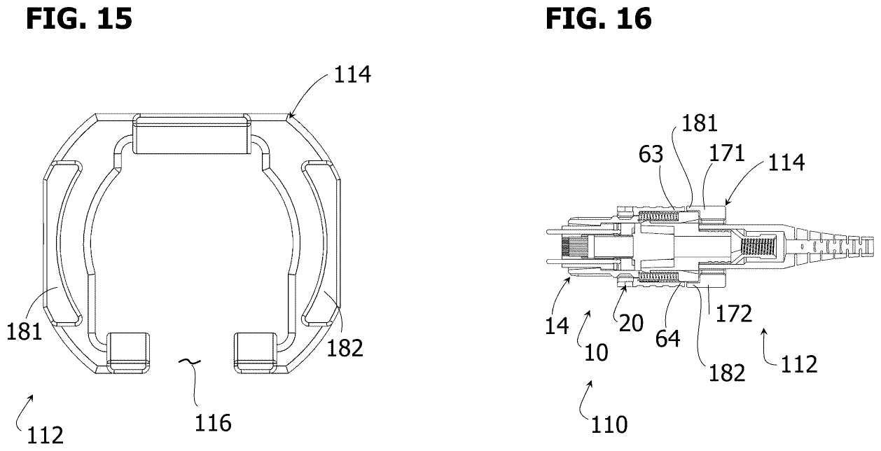

Referring now to FIGS. 5-17, one example embodiment of a lockable fiber optic connector assembly in the scope of the present disclosure is generally indicated at reference number 110. The lockable fiber optic connector assembly 110 includes the MPO connector 10 and a lock 112 configured to be removably installed on the MPO connector at a locking position (see, e.g., FIGS. 7-11, 16-17) when the MPO connector is mated with an MPO adapter (not shown) and the outer release sleeve 20 is in the front position.

The lock 112 comprises a bracket 114 shaped and arranged for straddling the cable boot 22. The bracket 114 as shown in the drawings has an inverted U-shape, with a cable boot opening 116 through which the cable boot 22 or cable is passable to load the lock 112 onto the MPO connector 10. The bracket 114 comprises a first wall portion 121, an opposite second wall portion 122, a third wall portion 123, and a fourth wall portion 124 opposite the third wall portion. The second wall portion 122 includes two segments on opposite sides of the cable boot opening 116.

In the illustrated embodiment, the lock 112 comprises a first arm 131 protruding forward from the first wall portion 121 and a second arm 132 protruding forward from the second wall portion 122. The second arm 132 is broken into two arm sections on opposite sides of the cable boot opening 116. A first front finger 141 protrudes inward from the first arm 131 toward the second arm 132, and a second front finger 142 protrudes inward from the second arm toward the first arm. Each front finger 141, 142 is configured to fit in one of the gaps 71, 72 when the lock is installed on the MPO connector 10 at the locking position. In the illustrated embodiment, the first front finger 141 defines a first rearward facing locking surface portion 151, and the second front finger 142 defines a second rearward facing locking surface portion 152. When the lock 112 is installed at the locking position, the first and second rearward facing locking surface portions 151, 152 are configured to oppose the first and second forward facing surface portions 41, 42 of the inner housing 14 of the MPO connector 10. Each front finger 141, 142 also has a leading chamfer 161, 162 opposite the respective rearward facing locking surface portion 151, 152. Each leading chamfer 161, 162 is shaped and arranged such that the front finger 141, 142 is configured to snap over the respective flange portion 38, 40 when the lock 112 is positioned astraddle the cable boot 22 and advanced forward along the longitudinal axis LA to the installed position.

The illustrated lock 112 further comprises a first stop 171 protruding forward from the third wall portion 123 of the bracket 114, and a second stop 172 protruding forward from the fourth wall portion 124. In other words, the lock comprises first and second stops 171, 172 on opposite sides of the bracket 114. The first stop 171 defines a first forward facing locking surface portion 181, and the second stop 172 defines a second forward facing locking surface portion 182. The first and second forward facing locking surface portions 181, 182 are configured to oppose the rearward facing surface portions 63, 64 defined by the third and fourth latch covering sides 53, 54 of the outer release sleeve 20 of the MPO connector 10 when the lock 112 is in the installed position.

Accordingly, it can be seen that the lockable MPO connector assembly 110 broadly comprises a lock 112 comprising a forward facing locking surface (forward facing locking surface portions 181, 182) and a rearward facing locking surface (reward facing locking surface portions 151, 152), where the forward facing locking surface is shaped and arranged to oppose the rearward facing surface (rearward facing surface portions 63, 64) of the outer release sleeve 20 and the rearward facing locking surface is shaped and arranged to simultaneously oppose the forward facing surface (forward facing surface portions 41, 42) of the flange 38, 40 of the inner housing 14 when the lock is installed at the locking position. Thus, in the locking position, the lock 112 is configured so that the rearward facing surface (rearward facing surface portions 63, 64) of the outer release sleeve 20 will engage the forward facing locking surface (forward facing locking surface portions 181, 182) and the forward facing surface (forward facing surface portions 41, 42) of the flange 38, 40 will engage the rearward facing locking surface (rearward facing locking surface portions 151, 152) to block the outer release sleeve from moving from the front position toward the rear position to release the MPO connector 10 from the MPO adapter. This locks the MPO connector 10 in the MPO adapter when the lock 110 is installed at the locking position.

To use the lockable fiber optic connector assembly 110, first the MPO connector 10 is plugged into a mating adapter (not shown). As known to those skilled in the art, when the MPO connector 10 is fully plugged-in, the outer release sleeve 20 is positioned in the front position where it covers adapter latch arms (not shown) engaged with the detent features 36 of the inner housing 14. After plugging the MPO connector 10 into the MPO adapter, the lock 112 is installed on the MPO connector 10 so that the lock simultaneously opposes a rearward facing surface (in this case, surface portions 63, 34) of the outer release sleeve 20 and a forward facing surface (in this case, surface portions 41, 42) of the inner housing 14.

The lock 112 is installed by passing the cable boot 12 into the bracket 114 through the cable boot opening 116 and then advancing the lock forward longitudinally until the front fingers 141, 142 snap over the flange 38, 40 and are received in the gaps 71, 72. In this position, the first rearward facing locking surface portion 151 opposes the first forward facing surface portion 41, the second rearward facing locking surface portion 152 opposes the second forward facing surface portion 42, the first forward facing locking surface portion 181 opposes the third rearward facing surface portion 63, and the second forward facing locking surface portion 182 opposes the fourth rearward facing surface portion 64. Once the lock is installed this way, it prevents extraction of the MPO connector 10 from the MPO adapter by rearward displacement of the outer release sleeve 20 in relation to the inner housing 14. The lock 112 must be removed before extracting the MPO connector 10 from the adapter.

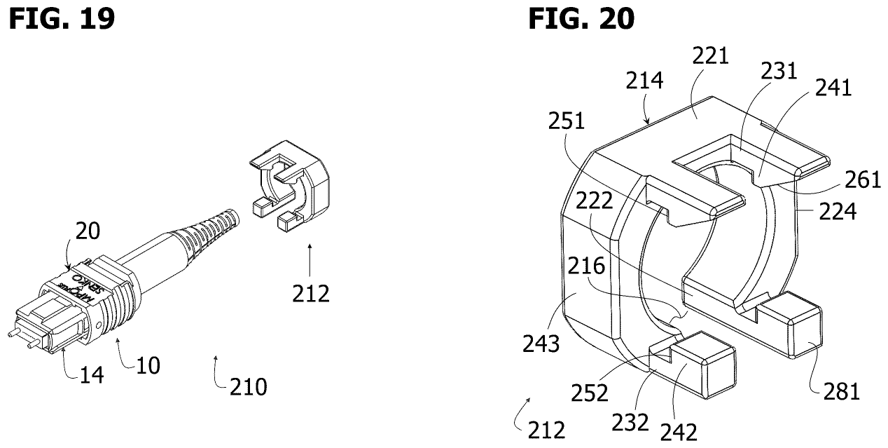

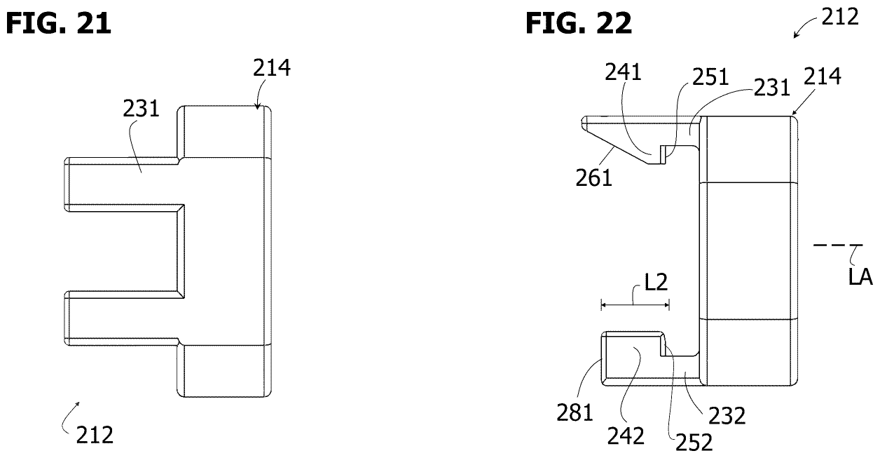

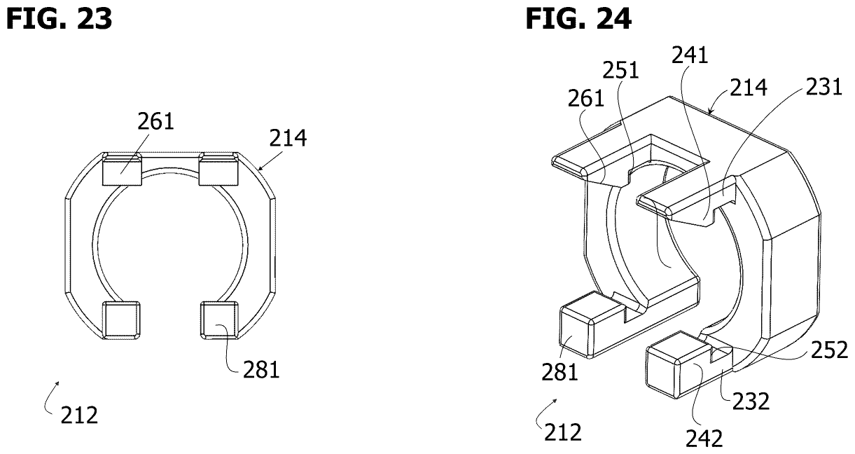

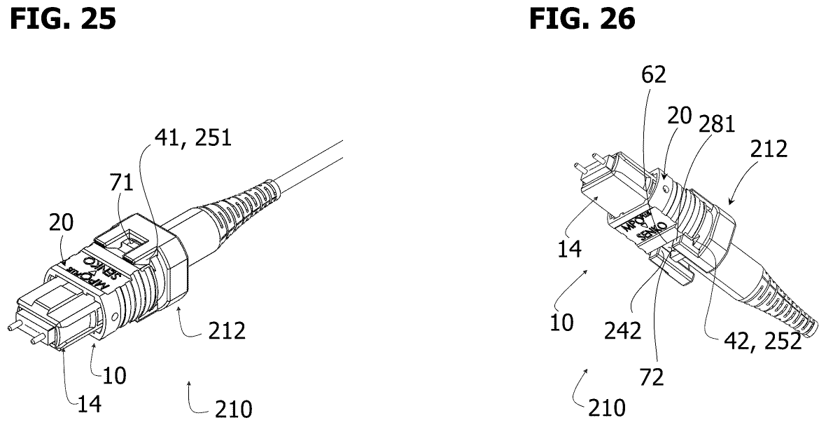

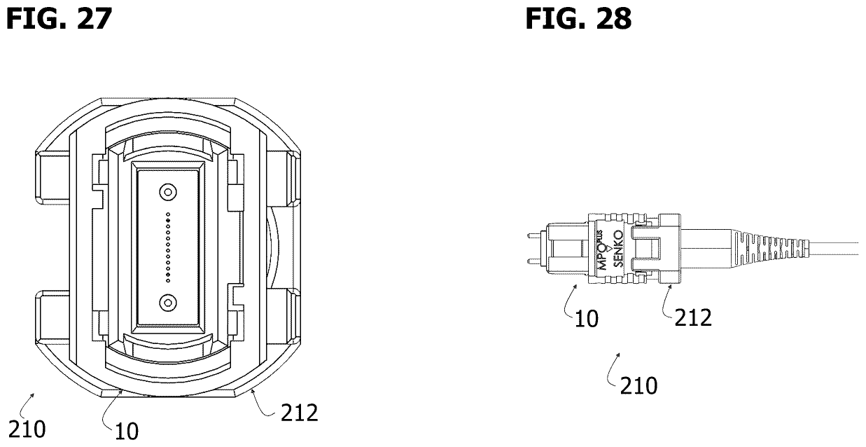

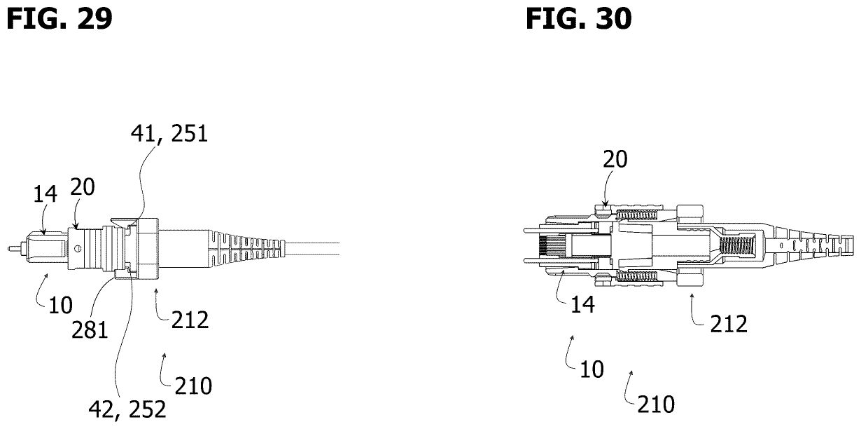

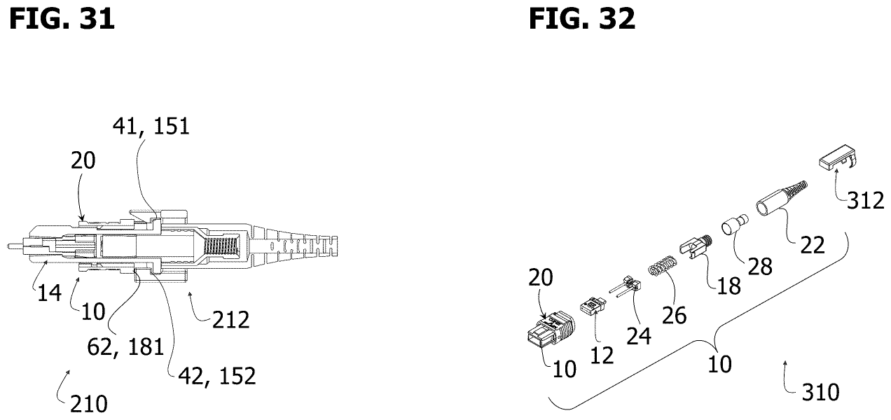

Referring to FIGS. 18-31, another embodiment of a lockable fiber optic connector assembly is generally indicated at reference number 210. The lockable fiber optic connector assembly 210 includes the MPO connector 10 and a lock 212. The lock 212 is similar in many respects to the lock 112, and corresponding reference parts are given the same reference number, plus 100. The lock 212 is similar to the lock 112 in that the lock 212 comprises a bracket 214 configured to straddle the cable boot 22. The bracket 212 comprises a first wall portion 221, an opposite second wall portion 222, a third wall portion 223, and a fourth wall portion 224 opposite the third wall portion. The bracket 212 defines a cable boot opening 216 along the second wall portion 222. The lock 212 differs from the lock 112 in that the lock 212 lacks stops protruding forward from the third and fourth wall portions 223, 224.

The lock 212 comprises a first arm 231 (which is subdivided into two arm segments in the illustrated embodiment) protruding forward from the first wall portion 221, a second arm 232 (which is subdivided into two arm segments on opposite sides of the cable boot opening 216) protruding forward from the second wall portion 22, a first front finger 241 protruding inward from the first arm 231, and a second front finger 242 protruding inward from the second arm 232. The first and second front fingers 241 define rearward facing locking surface portions 251, 252, but only the first front finger 241 has a front chamfer 261 in the illustrated embodiment. The front end of the second front finger 242 defines a forward facing locking surface 281 configured to extend in a plane generally perpendicular to the fiber alignment axis FA and the transverse axis TA when the lock 212 is in the locking position. In the locking position, the first front finger 241 is configured to be received in the first gap 71 and the second front finger 242 is configured to be received in the second gap 72.

It can be seen that the lockable fiber optic connector assembly 210 broadly comprises a lock 212 comprising a forward facing locking surface 281 and a rearward facing locking surface defined by the reward facing surface portions 251, 252, where the forward facing locking surface is shaped and arranged to oppose the rearward facing surface defined by rearward facing surface portion 62 of the outer release sleeve 20 and the rearward facing locking surface is shaped and arranged to simultaneously oppose the forward facing surface defined by forward facing surface portions 41, 42 of the flange 38, 40 of the inner housing 14 when the lock is installed at the locking position. Thus, in the locking position, the fingers 241, 242 are received in the gaps 71, 72 so that, if the outer release sleeve 20 is pulled backward, the rearward facing surface 62 of the outer release sleeve 20 will engage the forward facing locking surface 281 and the forward facing surface portions 41, 42 of the flange 38, 40 will engage the rearward facing locking surface portions 251, 252 to block the outer release sleeve from releasing the MPO connector 10 from the MPO adapter.

In the illustrated embodiment, the second front finger 242 has a length L2 (FIG. 22) extending along the longitudinal axis LA from the forward facing locking surface 281 to the rearward facing locking surface portion 252. In one or more embodiments, the length L2 is from 80% to 100% of the length L1 of the gap 72. Hence, the second front finger 242 is configured to substantially fill the gap 72 in the locking position such that the clearance provided by the gap 72 for backward displacement of the outer release sleeve 20 is effectively eliminated when the lock 212 is installed.

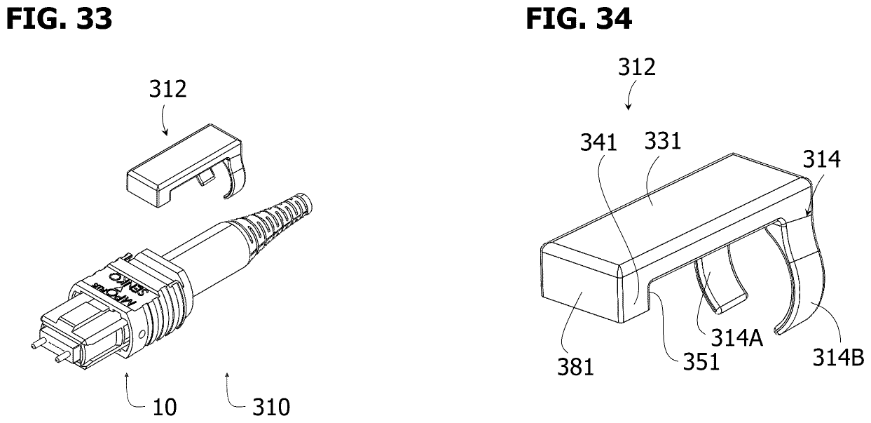

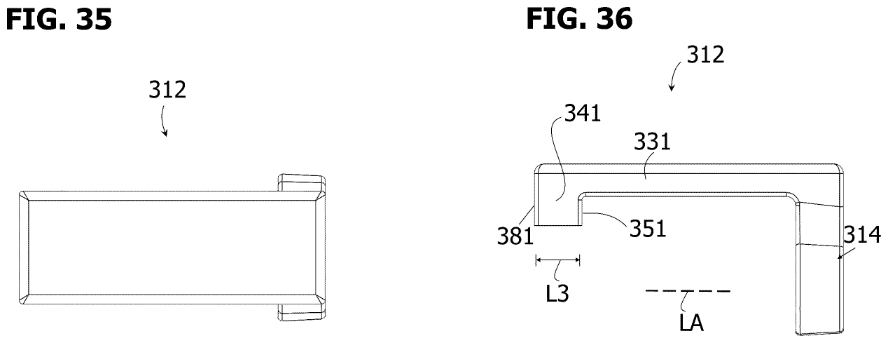

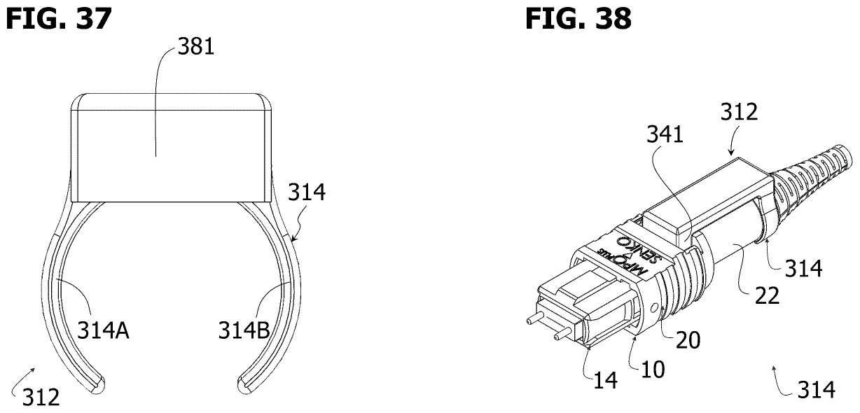

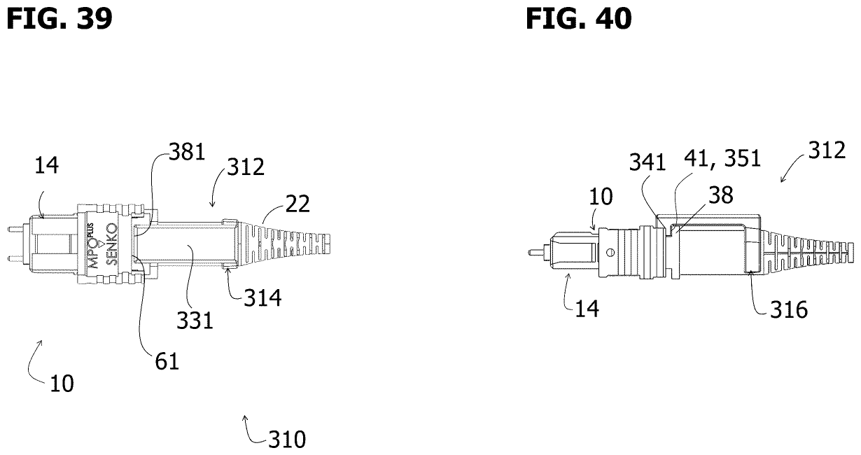

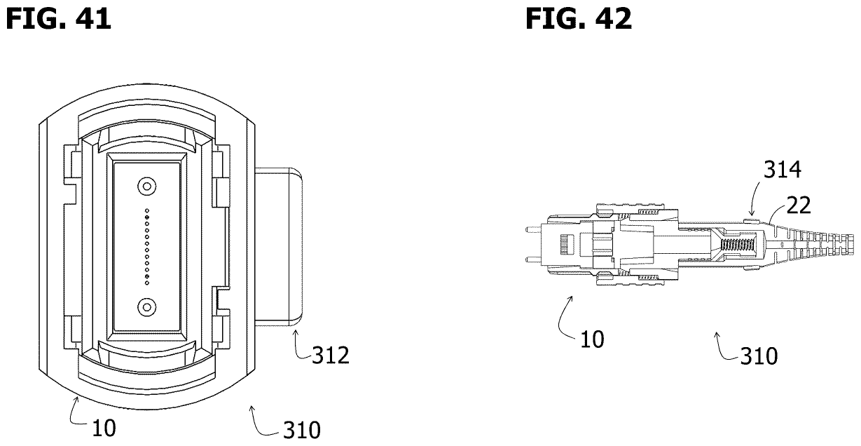

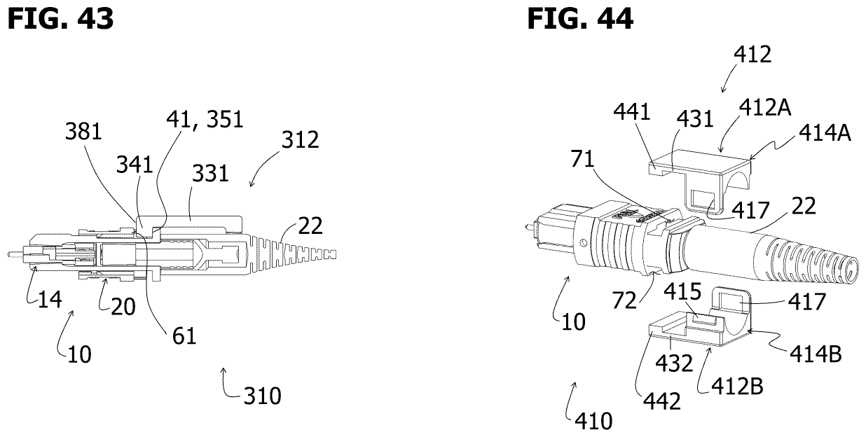

Referring to FIGS. 32-43, another embodiment of a lockable fiber optic connector assembly is generally indicated at reference number 310. The lockable fiber optic connector assembly 310 includes the MPO connector 10 and a lock 312. The lock 312 is similar in some respects to the lock 112, and corresponding reference parts are given the same reference number, plus 200. The lock 312 comprises a bracket 314 configured to engage the cable boot 22 when the lock is installed at the locking position. An arm 331 protrudes forward from the bracket 314, and the bracket defines a boot opening 316 on an opposite side of the bracket from the arm. The illustrated bracket 314 is a clip comprising first and second resilient bracket arms 314A 314B. The bracket 314 is a U-shaped clip body configured to clip onto the cable boot 22 directly to secure the lock 312 to the MPO connector 10.

The arm 331 protruding forward from the bracket 312. A front finger 341 protudes inward from the arm 331 for reception in the gap 71 between the forward facing surface 41 and the rearward facing surface 61. The front finger 341 defines the forward facing locking surface 381 and the rearward facing locking surface 351 of the lock 312. In the illustrated embodiment, the finger 341 has a length L3 (FIG. 36) extending along the longitudinal axis LA from the forward facing locking surface 381 to the rearward facing locking surface 351. In one or more embodiments, the length L3 is from 80% to 100% of the length L1.

The lock 312 is configured to be installed by moving the lock toward the MPO connector 10 along the transverse axis TA. The front finger 341 is received between the forward facing surface 41 of the inner housing 14 and the rearward facing surface 61 of the outer release sleeve 20, and the cable boot 22 passes through the boot opening 316 so that the first and second resilient bracket arms 314A, 314B snap over and clip onto the cable boot.

Thus, it can be seen that the lockable MPO connector assembly 310 broadly comprises a lock 312 comprising a clip-on bracket 314 and front finger 341 configured to fit into the gap 71 when the bracket is clipped onto the cable boot 22. The finger's forward facing locking surface 281 is shaped and arranged to oppose the rearward facing surface portion 62 of the outer release sleeve 20 and the finger's rearward facing locking surface 251 is shaped and arranged to simultaneously oppose the forward facing surface portion 41 of the flange portion 38 of the inner housing 14. Thus, in the locking position, the finger 341 blocks the outer release sleeve 20 from moving from the front position toward the rear position to release the MPO connector 10 from the MPO adapter. This locks the MPO connector 10 in the MPO adapter when the lock 312 is installed at the locking position.

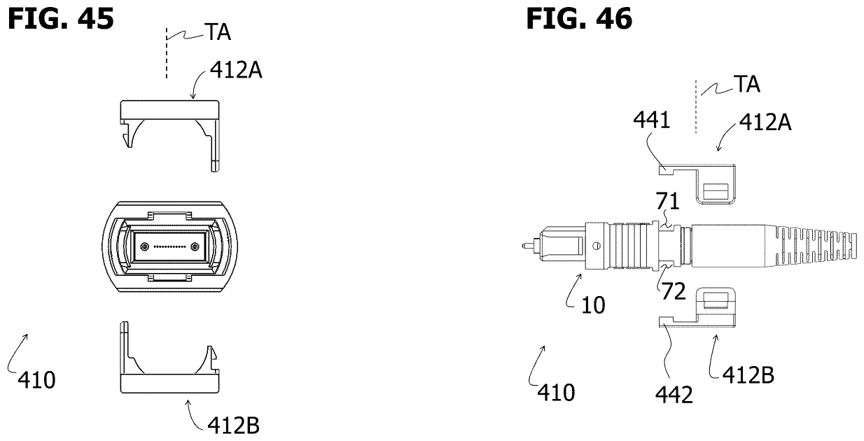

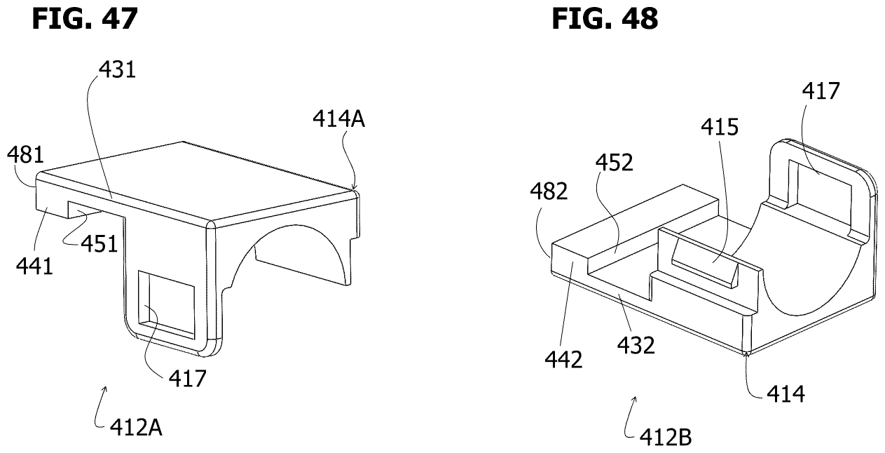

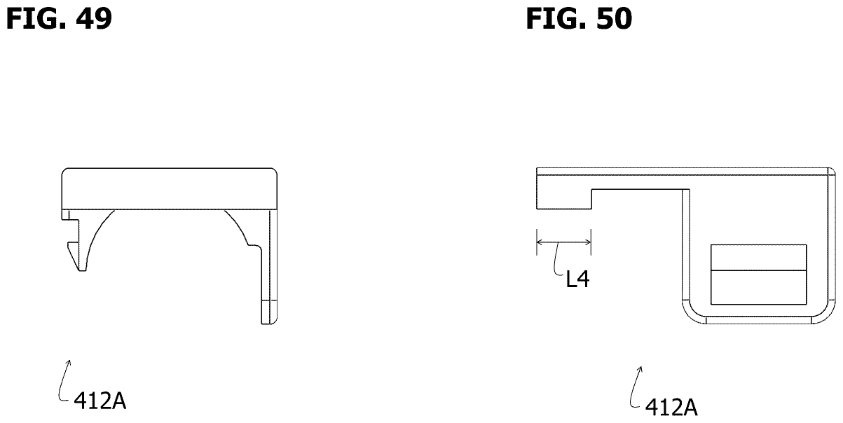

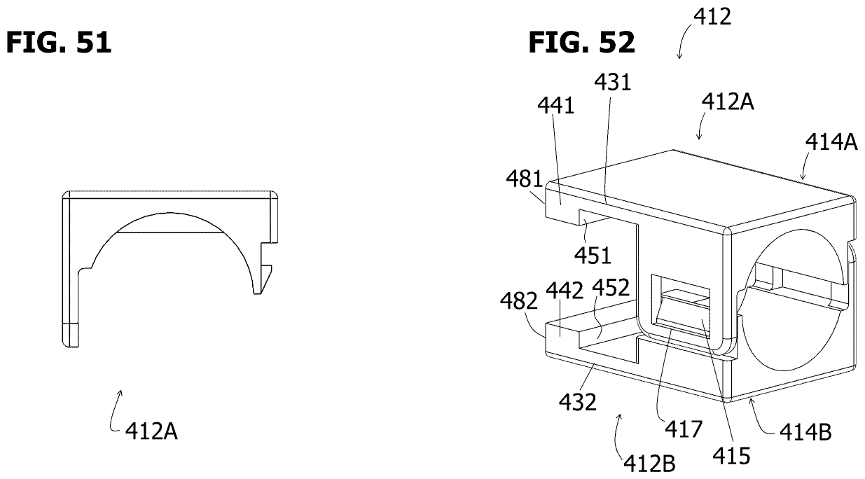

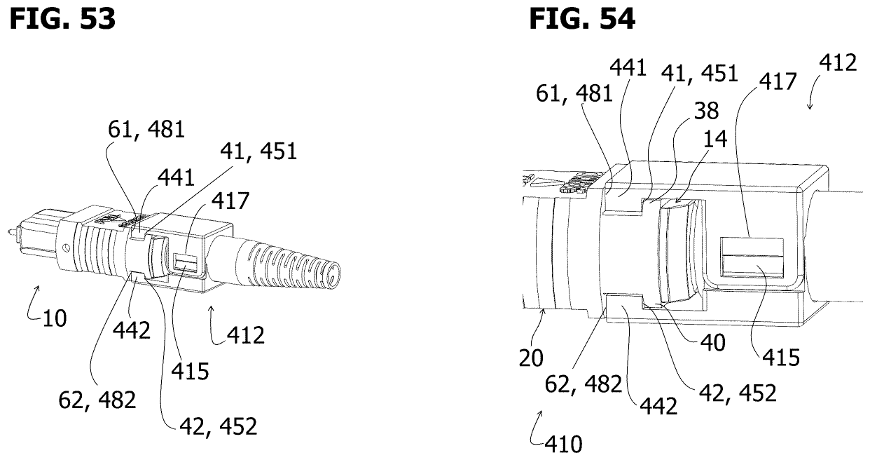

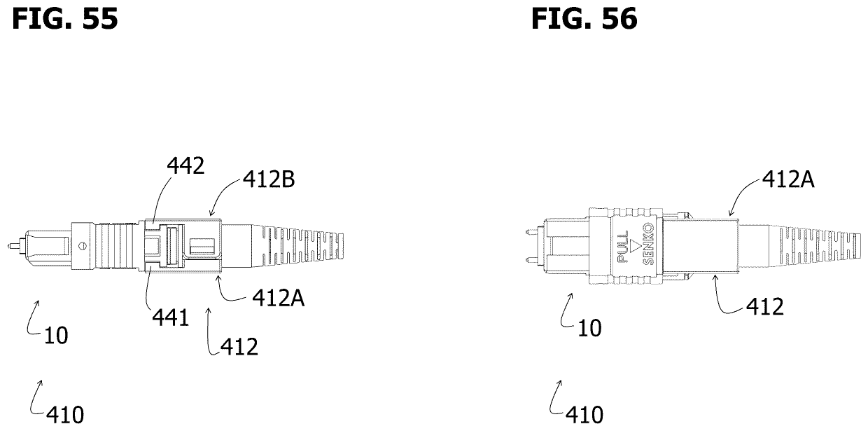

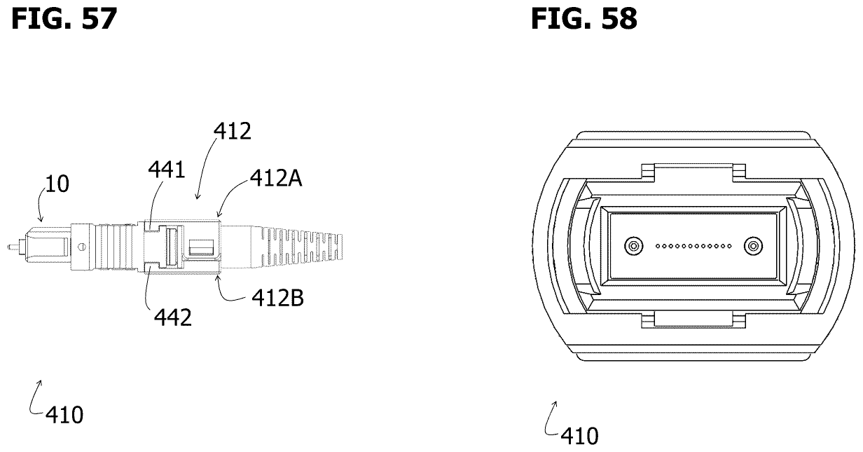

Referring to FIGS. 44-58, another embodiment of a lockable fiber optic connector assembly is generally indicated at reference number 410. The lockable fiber optic connector assembly 410 includes the MPO connector 10 and a lock 412. The lock 412 is similar in some respects to the lock 112, and corresponding reference parts are given the same reference number, plus 300.

Unlike the preceding locks 112, 212, 312 (which are all monolithic one-piece components) the lock 412 is a two-piece lock that comprises first and second lock portions 412A, 412B configured to be fastened together to install the lock at the locking position. In the illustrated, non-limiting embodiment, the first and second lock portions 412A, 412B are identical parts. Each lock portion 412A comprises a bracket 414A, 414B. In the illustrated embodiment, the brackets 414A, 414B cach have a U-shape. The brackets 414A, 414B comprise complementary fittings 415, 417 configured to fasten the brackets together around the cable boot 22 and install the lock 412 on the MPO connector 10. In the illustrated embodiment, the complementary fittings include a latch 415 and a complementary latch recess 417. Each latch 415 is configured to snap into the latch recess 417 when the brackets are brought together on the cable boot 22.

The first lock portion 412A further comprises a first arm 431 protruding forward from the first bracket 414A and a first front finger 441 protruding inward from the first arm. The first front finger 441 is configured for being received in the first gap 71 when the lock 412 is installed at the locking position. Similarly, the second lock portion 412B comprises a second arm 432 protruding forward from the second bracket 414B and a second front finger 442 protruding inward from the second arm. The second front finger 442 is configured for being received in the second gap 72 when the lock 412 is installed at the locking position. The first front finger 441 defines a first rearward facing locking surface portion 451 configured to oppose the first rearward facing surface portion 41 of the MPO inner housing 14 and a first forward facing locking surface portion 481 configured to oppose the first rearward facing surface portion 61 of the MPO outer release sleeve 20. Similarly, the second front finger 442 defines a second rearward facing locking surface portion 452 configured to oppose the second rearward facing surface portion 42 of the MPO inner housing 14 and a second forward facing locking surface portion 482 configured to oppose the second rearward facing surface portion 62 of the MPO outer release sleeve 20. Each finger 441, 442 has a has a length L4 (FIG. 50) extending along the longitudinal axis LA from the forward facing locking surface portion 481, 482 to the rearward facing locking surface portion 451, 452. In one or more embodiments, the length L4 is from 80% to 100% of the length L1 of the gaps 71, 72.

The lock 412 is configured to be installed by moving the first lock portion 412A toward the second lock portion 412B along the transverse axis TA to both (i) fasten the first bracket 414A to the second bracket 414B and (ii) load the first and second front fingers 441, 442 in the first and second gaps 71, 72. Accordingly, when the MPO connector 10 is mated with an MPO adapter, the outer release sleeve 20 is in the front position, and the lock 412 is secured at the installed position, the fingers 441, 442 positioned in the gaps 71, 72 block the outer release sleeve 20 from being pulled backward in relation to the inner MPO housing 14 and thereby prevent the MPO connector 10 from being extracted from the MPO adapter. In this position, the forward facing locking surface defined by the forward facing locking surface portions 481, 482 opposes the rearward facing surface defined by the rearward facing surface portions 61, 62 of the outer release sleeve 20 and the rearward facing locking surface defined by the rearward facing locking surface portions 451, 452 simultaneously opposes the forward facing surface defined by the forward facing surface portions 41, 42 of the flange 38, 40 of the inner housing 14. Thus, if the outer release sleeve 20 is pulled backward, the rearward facing surface portions 61, 62 will engage the forward facing locking surface portions 481, 482 and the forward facing surface portions 41, 42 will engage the rearward facing locking surface portions 451, 452 to block the outer release sleeve from moving from the front position toward the rear position to release the MPO connector 10 from the MPO adapter. This locks the MPO connector 10 in the MPO adapter when the lock 412 is installed at the locking position.

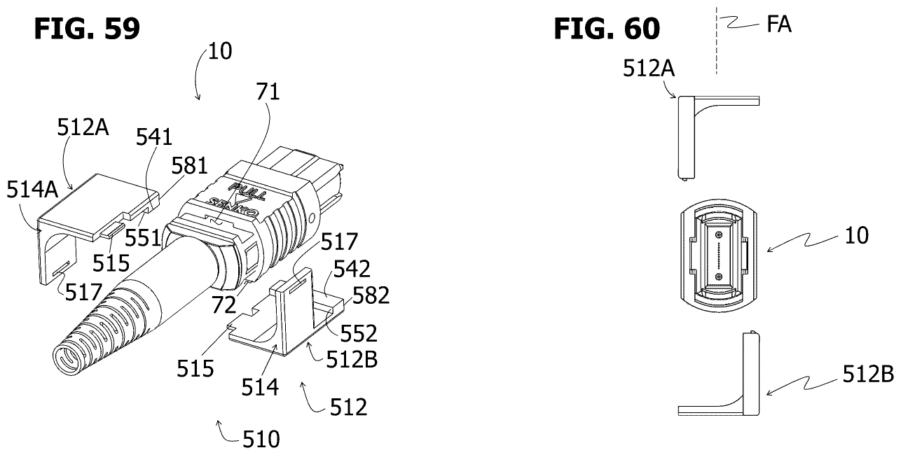

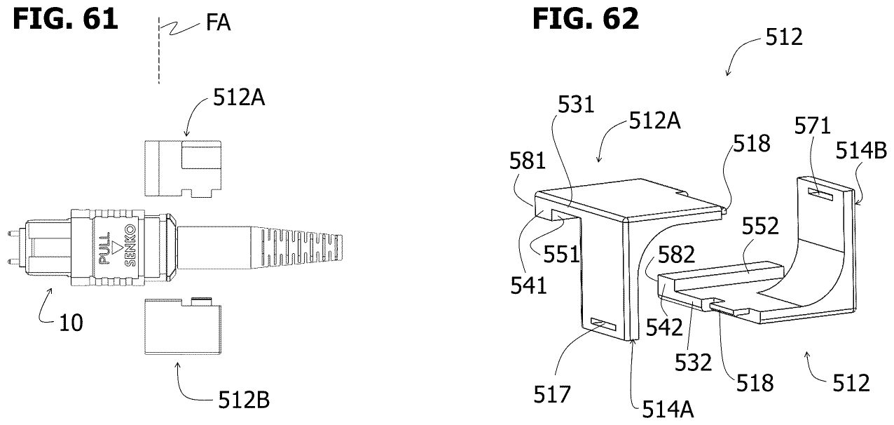

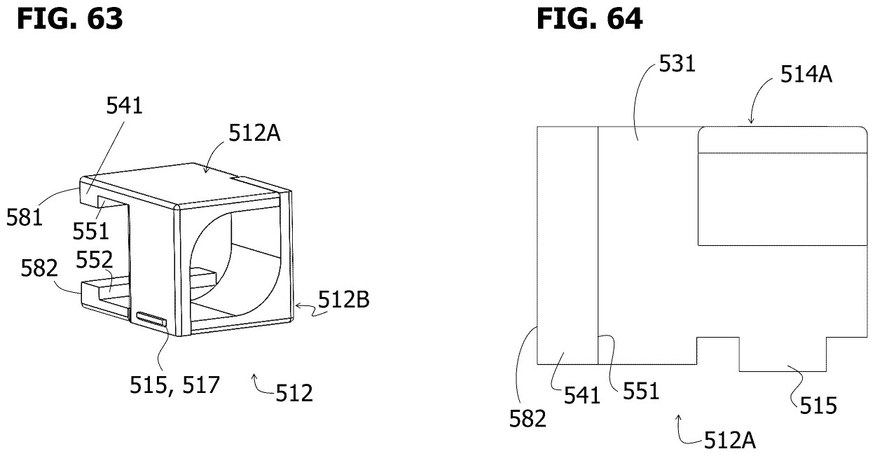

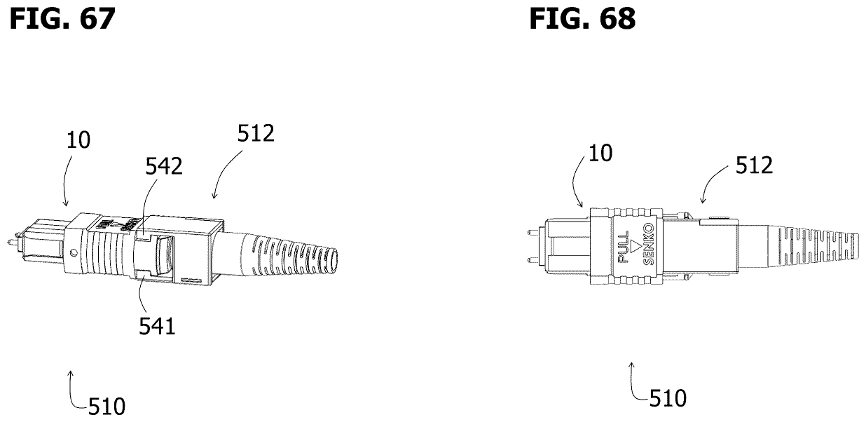

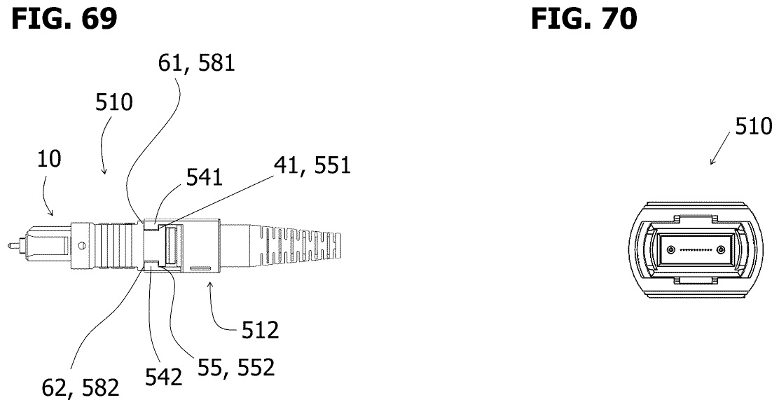

Referring to FIGS. 59-70, another embodiment of a lockable fiber optic connector assembly is generally indicated at reference number 510. The lockable fiber optic connector assembly 510 includes the MPO connector 10 and a lock 512. The lock 512 is similar two-piece lock to the lock 412 used in the lockable fiber optic connector assembly 410, and corresponding reference parts are given the same reference number, plus 100.

The lock 512 comprises first and second lock portions 512A, 512B configured to be fastened together to install the lock at the locking position. In the illustrated, non-limiting embodiment, the first and second lock portions 512A, 512B are identical parts. Each lock portion 512A comprises a bracket 514A, 514B. In the illustrated embodiment, the brackets 514A, 514B each have an L-shape. The brackets 514A, 514B comprise complementary fittings 515, 517 configured to fasten the brackets together around the cable boot 22 and install the lock 512 on the MPO connector 10. In the illustrated embodiment, the complementary fittings include a latching post 515 (broadly, a latch) and a complementary latch recess 517. Each latching post 515 is configured for snap-fit connection with the other bracket 514A, 514B when the latching post 515 is inserted into the latch recess 517 when the brackets are brought together by movement toward one another along the fiber alignment axis FA.

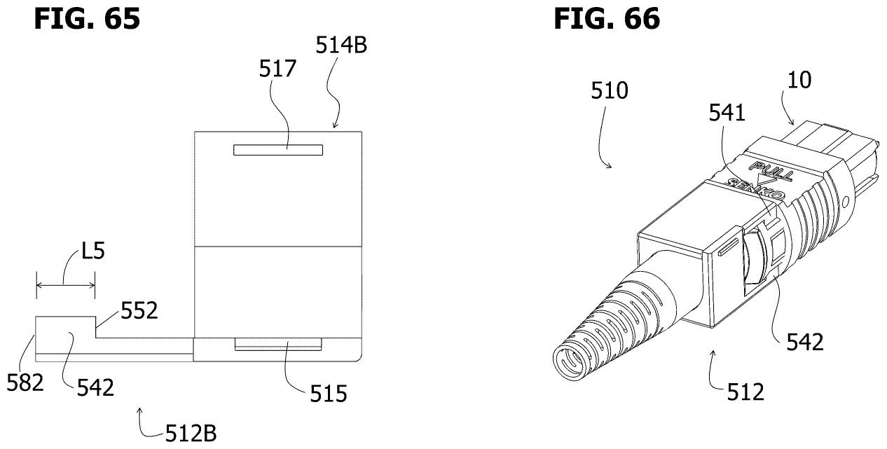

The first lock portion 512A further comprises a first arm 531 protruding forward from the first bracket 514A and a first front finger 541 protruding inward from the first arm. The first front finger 541 is configured for being received the first gap 71 when the lock portion 512A is moved along the fiber alignment axis FA when installing the lock 514 on the MPO connector 10. Similarly, the second lock portion 512B comprises a second arm 532 protruding forward from the second bracket 514B and a second front finger 542 protruding inward from the second arm. The second front finger 542 is configured for being received in the second gap 72 when the lock portion 512B is moved along the fiber alignment axis FA when installing the lock 512. The first front finger 541 defines a first rearward facing locking surface portion 551 configured to oppose the first forward facing surface portion 41 of the MPO inner housing 14 and a first forward facing locking surface portion 581 configured to oppose the first rearward facing surface portion 61 of the MPO outer release sleeve 20. Similarly, the second front finger 542 defines a second rearward facing locking surface portion 552 configured to oppose the second rearward facing surface portion 52 of the MPO inner housing 14 and a second forward facing locking surface portion 582 configured to oppose the second rearward facing surface portion 62 of the MPO outer release sleeve 20. Each finger 541, 542 has a has a length L5 (FIG. 65) extending along the longitudinal axis LA from the forward facing locking surface portion 581, 582 to the rearward facing locking surface portion 551, 552. In one or more embodiments, the length L5 is from 80% to 100% of the length L1 of the gaps 71, 72.

The lock 512 is configured to be installed by moving the first lock portion 512A toward the second lock portion 512B along the fiber alignment axis FA to both (i) fasten the first bracket 514A to the second bracket 514B and (ii) load the first and second front fingers 541, 542 in the first and second gaps 71, 72. Accordingly, when the MPO connector 10 is mated with an MPO adapter, the outer release sleeve 20 is in the front position, and the lock 512 is secured at the installed position, the fingers 541, 542 positioned in the gaps 71, 72 block the outer release sleeve 20 from being pulled backward in relation to the inner MPO housing 14 and thereby prevent the MPO connector 10 from being extracted from the MPO adapter. In this position, the forward facing locking surface defined by the forward facing locking surface portions 581, 582 opposes the rearward facing surface defined by the rearward facing surface portions 61, 62 of the outer release sleeve 20 and the rearward facing locking surface defined by the rearward facing locking surface portions 551, 552 simultaneously opposes the forward facing surface defined by the forward facing surface portions 41, 42 of the flange 38, 40 of the inner housing 14. Thus, if the outer release sleeve 20 is pulled backward, the rearward facing surface portions 61, 62 will engage the forward facing locking surface portions 581, 582 and the forward facing surface portions 41, 42 will engage the rearward facing locking surface portions 551, 552 to block the outer release sleeve from moving from the front position toward the rear position to release the MPO connector 10 from the MPO adapter. This locks the MPO connector 10 in the MPO adapter when the lock 512 is installed at the locking position.

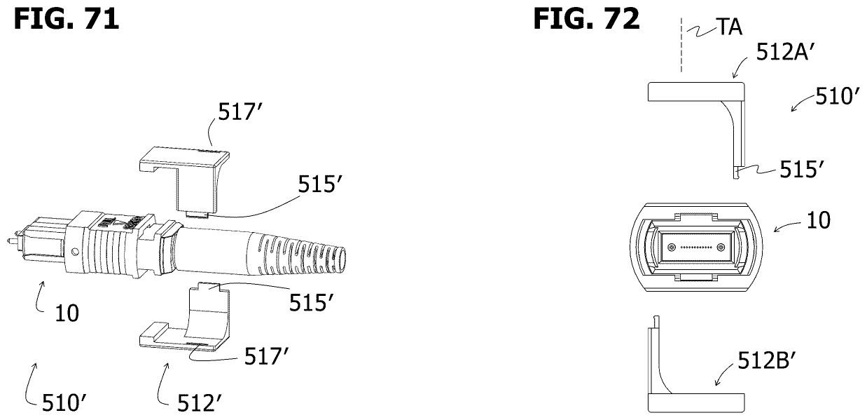

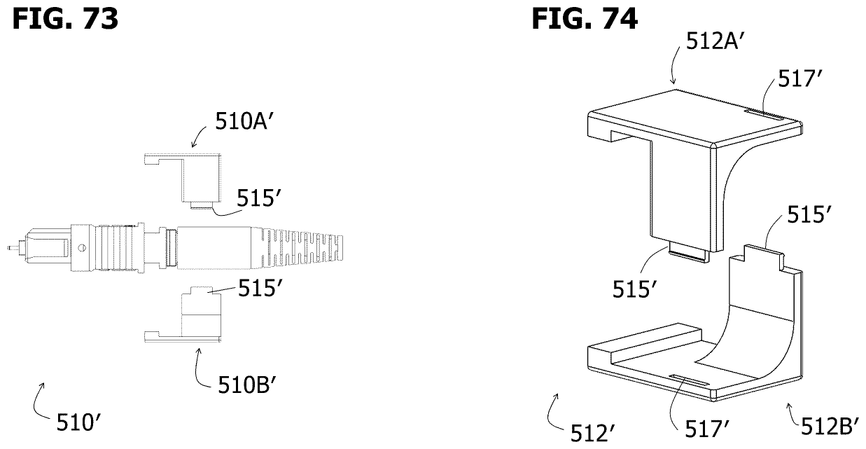

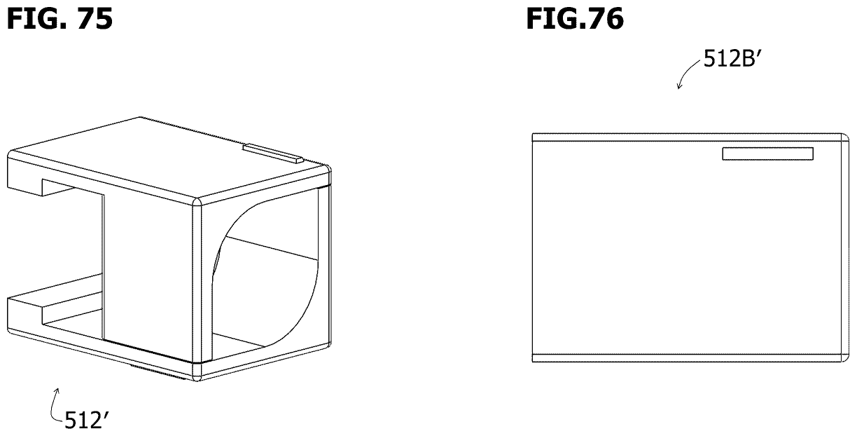

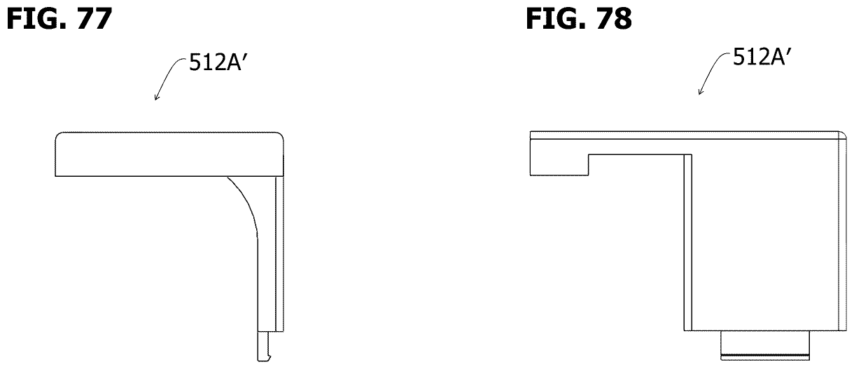

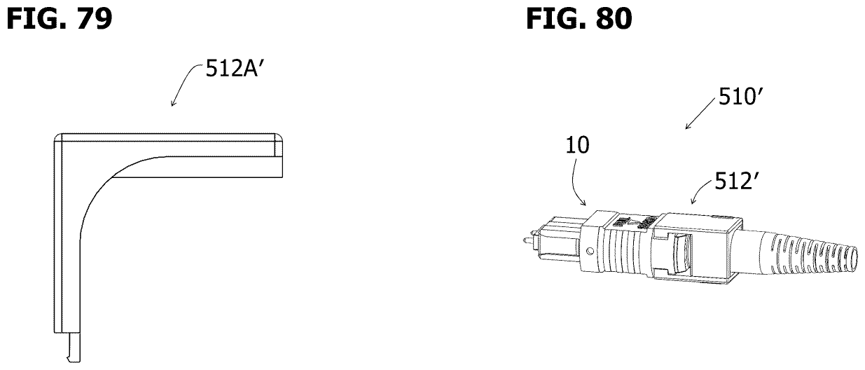

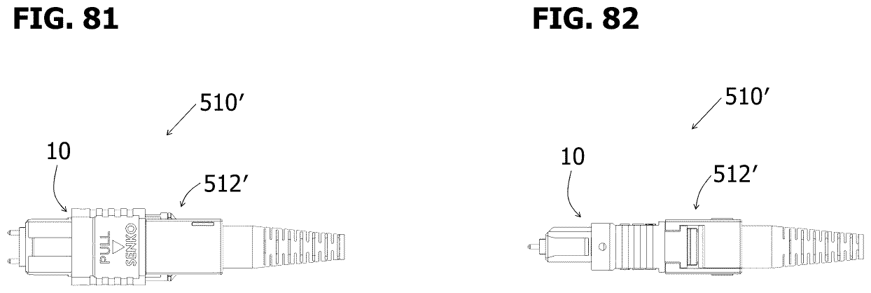

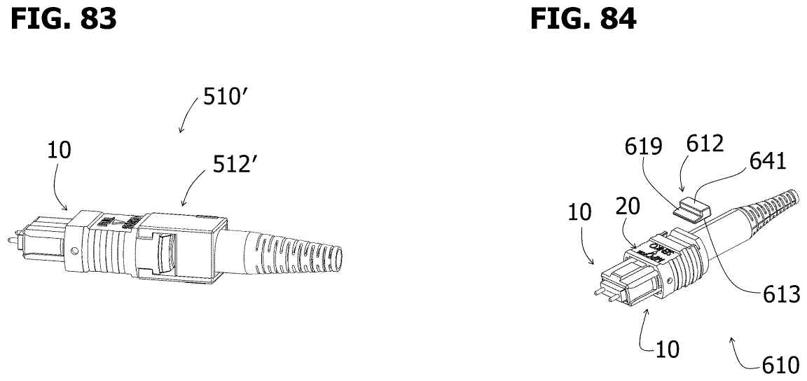

Referring to FIGS. 71-83, another embodiment of a lockable fiber optic connector assembly is generally indicated at reference number 510′. The lockable fiber optic connector assembly 510′ is substantially the same as the lockable fiber optic connector assembly 510 except that the orientation and position of the latch 515′ and latch recess 517′ on the first and second lock portions 512A′, 512B′ of the lock 512′ are changed so that the lock installs by bringing the first and second lock portions together along the transverse axis TA instead of the fiber alignment axis FA.

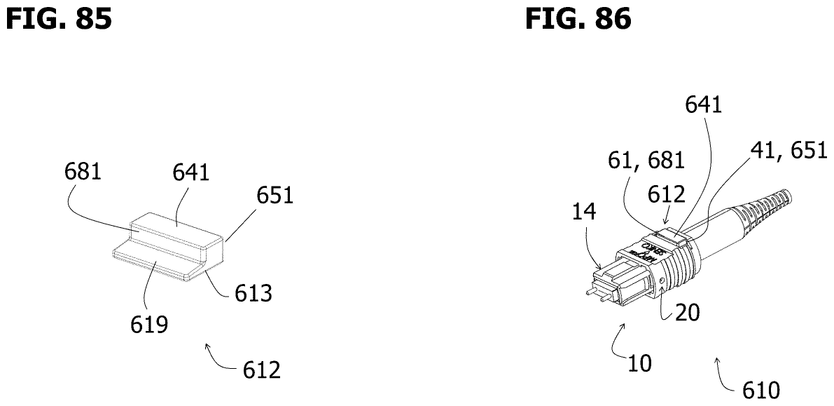

Referring to FIGS. 84-86, another embodiment of a lockable fiber optic connector assembly is generally indicated at reference number 610. The lockable fiber optic connector assembly 610 comprises the MPO connector 10 and a lock 612. The lock 112, 212, 312, 412, 512, 512′ in that it does not support itself on the cable boot 22. Instead, the lock 612 comprises a lock insert that is configured to be positioned on the MPO inner housing 14 in the gap 71 between the rearward facing surface portion 61 and the forward facing surface portion 41.

The lock insert 612 comprises a base 613 and a finger 641 upstanding from the base. The base comprises a toe 619 forward of the finger 641. The lock insert 612 is configured to be fitted between the outer release sleeve 20 and the inner housing 14 in the locking position such that the base 613 is supported on the first housing broad side 31, the toe 619 is received in the interface opening 70 and the finger 641 is received in the gap 71. The finger 641 defines the forward facing locking surface 681 and the rearward facing locking surface 651 of the lock insert 612. In this embodiment, the rearward facing locking surface 651 is located at the rear end of the lock insert 612 and the forward facing locking surface 681 is located at a location spaced rearward from the front end of the insert. By contrast, in each preceding embodiment, the forward facing locking surface or surface portion was located at the front end of the respective lock and the rearward facing locking surface or surface portion was located at a location spaced apart forward of the rear end. The finger 641 has a length L6, and in one or more embodiments, the length L6 is from 80% to 100% of the length L1 of the gap 71.

The lock insert 612 is configured to be installed on a plugged-in MPO connector by inserting the toe 619 into the interface opening 70 (FIG. 17) and laying the base 613 down on the first housing broad side 631. This positions the finger 641 in the gap 71 to block the outer release sleeve 20 from being pulled backward in relation to the inner MPO housing 14. In this position, the forward facing locking surface 681 opposes the rearward facing surface portion 61 of the outer release sleeve 20 and the rearward facing locking surface 651 simultaneously opposes the forward facing surface portion 41 of the flange 38 of the inner housing 14. Thus, if the outer release sleeve 20 is pulled backward, the rearward facing surface portion 61 will engage the forward facing locking surface 681 and the forward facing surface portion 41 will engage the rearward facing locking surface 651 to block the outer release sleeve from moving from the front position toward the rear position to release the MPO connector 10 from the MPO adapter. This locks the MPO connector 10 in the MPO adapter when the lock insert 612 is installed at the locking position.

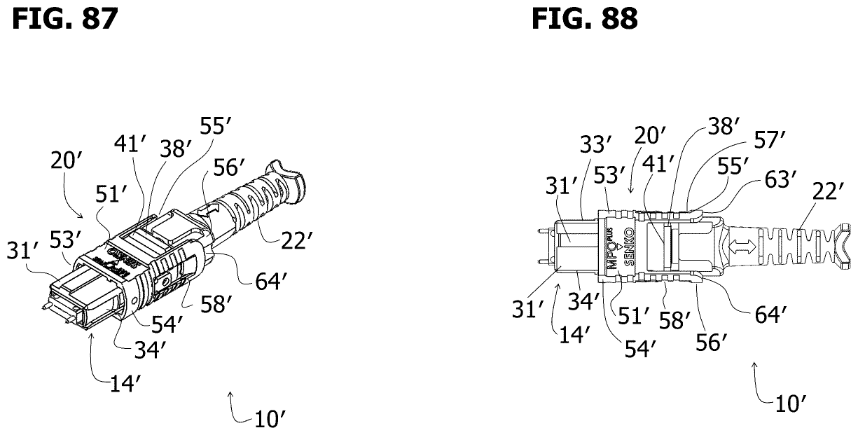

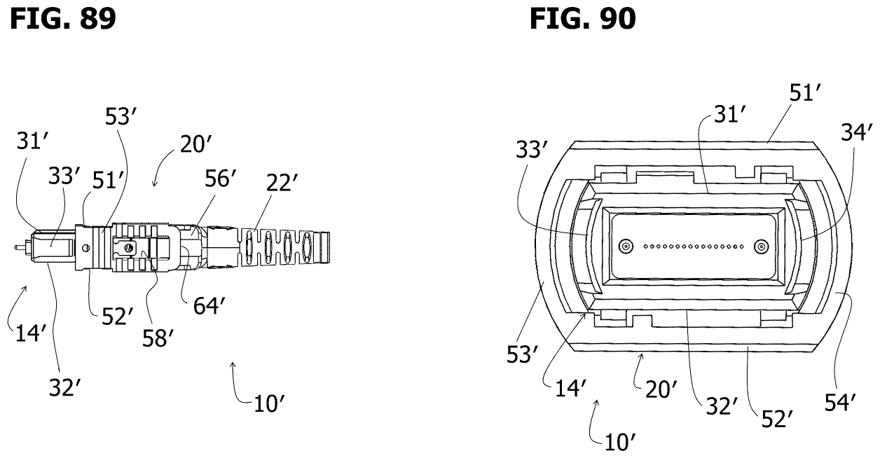

Referring to FIGS. 87-90, another embodiment of an MPO connector is generally indicated at reference number 10′. The MPO connector 10′ is similar to the MPO connector 10, and corresponding parts are given the same reference number followed by a prime symbol. The MPO connector 10′ generally differs from the MPO connector 10 in that the former is a push-pull boot connector. Specifically, the connector 10′ is an MPO EZ-WAY connector of the type sold by the assignee of the present disclosure. Additional information about MPO EZ-WAY-type connectors is available at US Patent Application Publication No. 2024/0142724.

Like the MPO connector 10, the MPO connector 10′ comprises an inner housing 14′ including first and second housing broad sides 31′, 32′, third and fourth latching sides 33′, 34′, first and second flange portions 38′ 40′ defining first and second forward facing surface portions 41′, 42′. The outer release sleeve 20′ of the MPO connector 10′ comprises first and second sleeve broad sides 51′, 52′ and third and fourth latch covering sides 53′, 54′. The latch covering sides 53′, 54′ comprise rearward projecting cars 55′, 56′ that define slots 57′ 58′ at which the outer release sleeve 20′ is operably coupled to a push-pull boot 22′. The cars 55′, 56′ define rearward facing surface portions 63′, 64′, which are located rearward of the forward facing surface portions 41′ 42′ of the inner housing flange 38′, 40′.

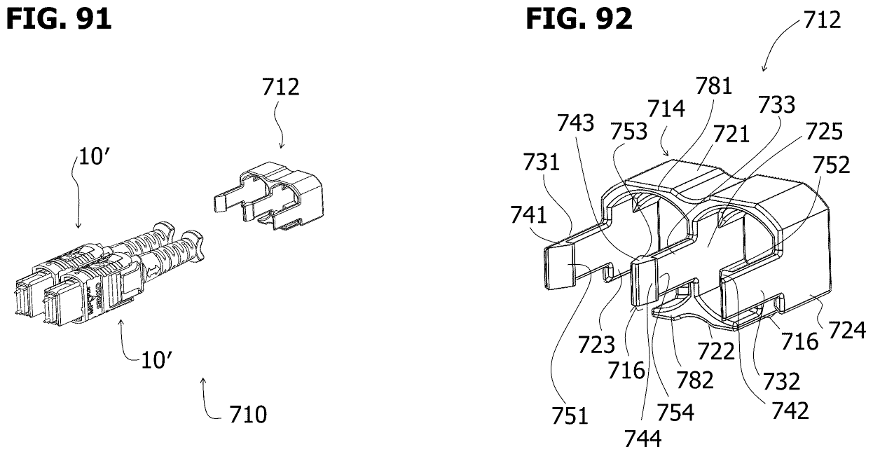

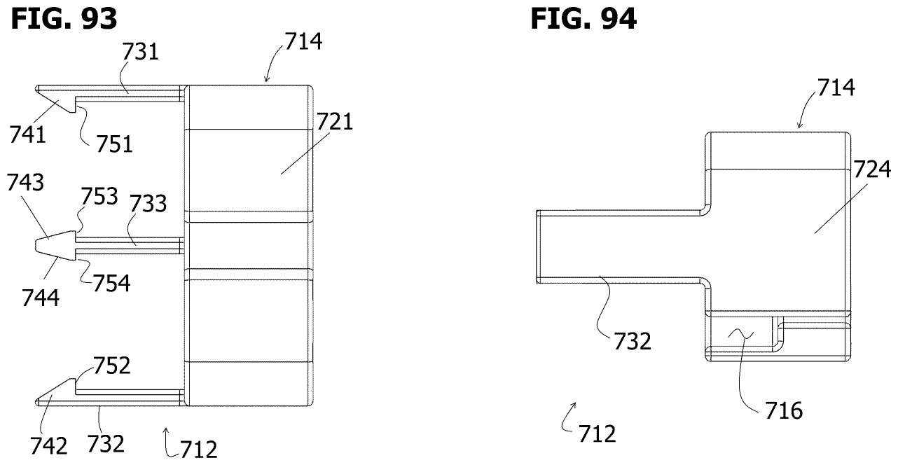

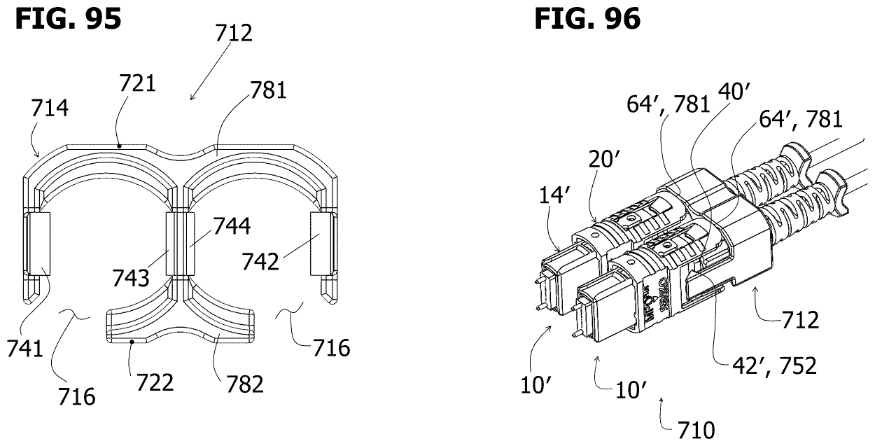

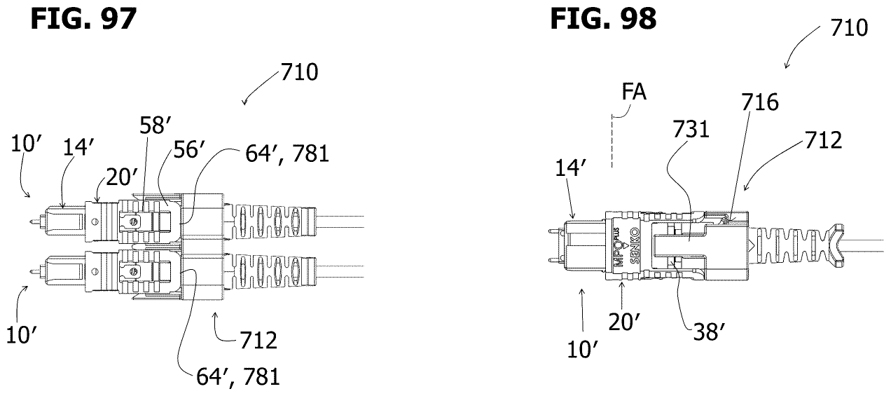

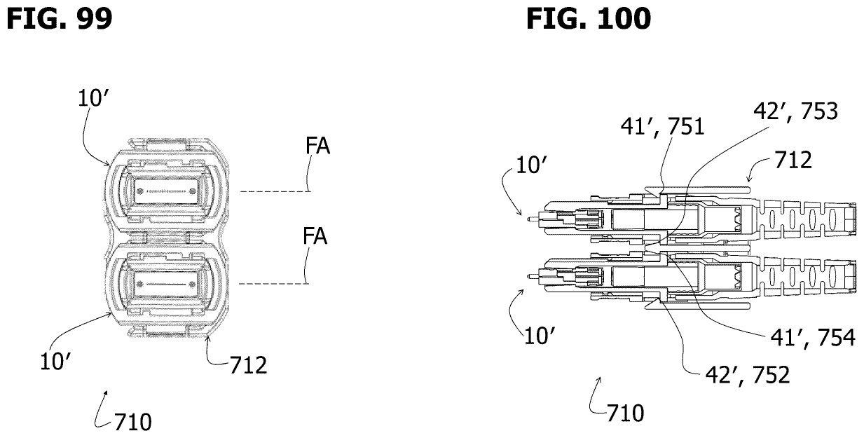

Referring to FIGS. 91-100, another embodiment of a lockable fiber optic connector assembly is generally indicated at reference number 710. The illustrated lockable fiber optic connector assembly 710 comprises two push-pull boot MPO connectors 10′ and a single-piece dual-connector lock 712. It will be understood that locking structures of the lock 710 (described below) could be adapted for use with other numbers of push-pull boot MPO connectors 10′ (e.g., one or more such connectors).

The illustrated lock 712 comprises an m-shaped bracket 714 configured to straddle the cable boots 22′ of both MPO connectors 10. The bracket 714 includes a first wall portion 721, an opposite second wall portion 722, a third wall portion 723 extending from one end of the first wall portion toward the second wall portion, a fourth wall portion 724 extending from the other end of the first wall portion toward the second wall portion, and a partition wall portion 725 extending from the first wall portion to the second wall portion. The partition wall portion 725 supports the second wall portion 722 on the first wall portion 721. The partition wall portion 725 also divides the interior of the bracket 714 into two receptacles. The bracket 712 defines a cable boot opening 716 into each receptacle through which the cable boots 22′ or cables of the MPO connectors 10′ are passable to load the lock 712′ onto the MPO connectors. In the illustrated example, the lock 712 is configured to be installed on the MPO connectors 10′ so that the first and second wall portions 721, 722 are spaced apart along the fiber alignment axes FA of the MPO connectors. The first wall portion 721 defines a first forward facing locking surface portion 781 and the second wall portion 722 defines a second forward facing locking surface portion 782. In one example, when the lock 712 is installed in the locking position, the first forward facing locking surface portion 781 opposes the rearward facing surface portions 63′ of both MPO connectors 10′ and the second forward facing locking surface portion 782 opposes the rearward facing surface portion 64′ of both connectors.

The lock 712 comprises outer arms 731, 732 that protrude forward from the third and fourth wall portions 723, 724 and a center arm 733 that protrudes forward from the partition wall portion 725. A first chamfered front finger 741 protrudes inward from the outer arm 731 and defines a first rearward facing locking surface portion 751. A second chamfered front finger 742 protrudes inward from the outer arm 732 and defines a second rearward facing locking surface portion 752. A third chamfered front finger 743 protrudes outward from the center arm 733 toward the first chamfered front finger 741 and defines a third rearward facing locking surface portion 753. Lastly, a fourth chamfered front finger 744 protrudes outward from the center arm 733 toward the second chamfered front finger 742 and defines a fourth rearward facing locking surface portion 754. When the lock 712 is in the locking position, the first and third rearward facing locking surface portions 751, 753 are configured to oppose the forward facing surface portions 41′, 42′ of one of the MPO connectors 10′, and the second and fourth rearward facing locking surface portions 752,754 are configured to oppose the forward facing surface portions 41′, 42′ of the other of the MPO connectors 10′.

Accordingly, when (i) the MPO connectors 10′ are mated with an MPO adapter(s), (ii) the outer release sleeves 20′ are in the front positions, and (iii) the lock 712 is secured at the installed position—the forward facing locking surface defined by the forward facing locking surface portions 781, 782 opposes the rearward facing surface of each MPO connector defined by the rearward facing surface portions 63′, 64′ of the outer release sleeves 20′ and the rearward facing locking surface defined by the rearward facing locking surface portions 751, 752, 753, 754 simultaneously opposes the forward facing surface defined by the forward facing surface portions 41′, 42′ of the flanges 38′, 40′ of the inner housings 14′. Thus, if either push-pull boot 22′ is pulled backward, the rearward facing surface portions 63′, 64′ will engage the forward facing locking surface portions 781′, 782′ and the forward facing surface portions 41′, 42′ will engage the respective rearward facing locking surface portions 751, 752, 753, 754 to block the outer release sleeve 20′ from moving from the front position toward the rear position to release the MPO connector 10′ from the MPO adapter. This locks both MPO connectors 10′ in the MPO adapter when the lock 712 is installed at the locking position. As can be seen, the lock 712 differs from the other lock embodiments described herein in that the forward facing locking surface defined by the forward facing locking surface portions 781, 782 is rearward of the rearward facing locking surface defined by the rearward facing locking surface portions 751, 752, 753, 754.

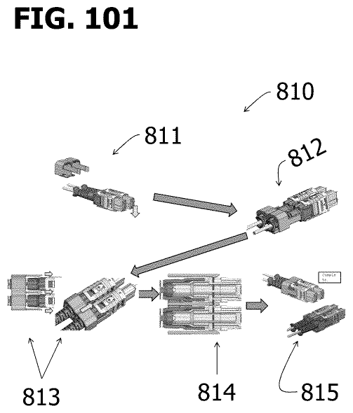

An exemplary method of installing the lock 712 onto the MPO connectors 10′ is depicted at reference number 810 in FIG. 101. At a step 811, the lock is loaded onto the push-pull boots 22′ in a radial direction (relative to the longitudinal axes of the MPO connectors 10′). Each push-pull cable boot 22′ is loaded into one of the receptacles, as shown at 812. Subsequently, as shown at 813, the lock 710 is advanced forward on the cable boots 22′ until the chamfered front fingers 741, 742, 743, 744 snap over the flange potions 38′ 40′ of the MPO inner housings 14′, as shown at 814. At 815, the lock 712 is in the installed position where it blocks the push-pull boots 22′ from pulling the outer release sleeves 22′ rearward for extracting the MPO connectors 10′ from mating adapters (not shown).

As can now be seen, this disclosure provides various lockable fiber optic connector assemblies that employ a lock to lock the pullback release element of a push-pull fiber optic connector in place after it has been mated with an adapter. Notably, each embodiment illustrated herein is low-profile in the sense that, when the lock is installed, at every circumferential position about a longitudinal center axis of the push-pull fiber optic connector, the imaginary radial line segment extending from the from the longitudinal center axis to the outermost perimeter point on the lock is less than 120% (e.g., less than 110%) of the radial line segment extending from the longitudinal center axis (in the same direction) to the outermost perimeter point on the push-pull fiber optic connector. This makes the example embodiments of the lockable fiber optic connector assemblies disclosed herein suitable for modern, high-density network installations.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A lockable fiber optic connector assembly comprising:
an MPO connector configured to mate with an MPO adapter, the MPO connector comprising a multifiber ferrule, an inner housing, and an outer release sleeve, the MPO connector having a longitudinal axis, the inner housing having a front end portion and a rear end portion spaced apart along the longitudinal axis, the inner housing comprising a flange at the rear end portion, the flange defining a forward facing surface, the outer release sleeve having a rearward facing surface, the outer release sleeve being movable in relation to the inner housing between a front position and a rear position, the outer release sleeve configured to secure the MPO connector in mated relationship with the MPO adapter when the outer release sleeve is in the front position and configured to release the MPO connector from the MPO adapter when the outer release sleeve is moved from the front position toward the rear position; and
a lock configured to be removably installed on the MPO connector at a locking position when the MPO connector is mated with the MPO adapter and the outer release sleeve is in the front position, the lock comprising a forward facing locking surface and a rearward facing locking surface, the forward facing locking surface shaped and arranged to oppose the rearward facing surface of the outer release sleeve and the rearward facing locking surface is shaped and arranged to simultaneously oppose the forward facing surface of the flange of the inner housing when the lock is installed at the locking position such that the lock is configured so that the rearward facing surface of the outer release sleeve will engage the forward facing locking surface and the forward facing surface of the flange will engage the rearward facing locking surface to block the outer release sleeve from moving from the front position toward the rear position to release the MPO connector from the MPO adapter, whereby the lock locks the MPO connector in the MPO adapter when the lock is installed at the locking position.

2. The lockable fiber optic connector assembly of claim 1, wherein the MPO connector is shaped and arranged to define a gap between the forward facing surface and the outer release sleeve and the lock comprises a finger configured to fit in the gap when the lock is installed at the locking position, the finger defining the rearward facing locking surface.

3. The lockable fiber optic connector assembly as set forth in claim 2, wherein the MPO connector comprises a cable boot and wherein lock further comprises bracket shaped and arranged to straddle the cable boot.

4. The lockable fiber optic connector assembly as set forth in claim 3, wherein the lock comprises an arm protruding forward from the bracket and having a front end portion, the finger protruding inward from the front end portion of the arm.

5. The lockable fiber optic connector assembly as set forth in claim 4, wherein the finger has a leading chamfer opposite the rearward facing locking surface, such that the finger is configured to snap over the flange when the lock in is positioned so that the bracket straddles the cable boot and is then advanced forward along the longitudinal axis to the installed position.

6. The lockable fiber optic connector assembly as set forth in claim 5, further comprising a stop protruding forward from the bracket, the stop being circumferentially spaced apart from the arm and defining the forward facing locking surface.

7. The lockable fiber optic connector assembly as set forth in claim 6, wherein the MPO connector has a fiber alignment axis perpendicular to the longitudinal axis and a transverse axis perpendicular to the fiber alignment axis and the longitudinal axis, wherein the wherein the inner housing comprises opposite first and second housing broad sides and opposite third and fourth latching sides, wherein the outer release sleeve comprises opposite first and second sleeve broad sides outboard of the first and second housing broad sides and opposite third and fourth latch covering sides outboard of the first and second latching sides, wherein the flange comprises a first flange portion formed on the first broad side and a second flange portion formed on the second broad side, wherein the forward facing surface comprises a first forward facing surface defined by the first flange portion and a second forward facing surface defined by the second flange portion, wherein the rearward facing surface comprises a first rearward facing surface portion defined by the third latch covering side and a second rearward facing surface portion defined by the fourth latch covering side;
wherein the stop comprises first and second stops on opposite sides of the bracket, the forward facing locking surface comprising a first forward facing locking surface portion defined by the first stop and a second forward facing locking surface portion defined by the second stop, the first and second forward facing locking surface portions configured to oppose the first and second rearward facing surface portions, respectively;
wherein the arm comprises first and second arms on opposite sides of the bracket and the finger comprises a first front finger protruding inward from the first arm and a second front finger protruding inward from the second arm, the rearward facing locking surface comprising a first rearward facing locking surface portion defined by the first front finger and a second rearward facing locking surface portion defined by the second front finger, the first and second forward rearward facing locking surface portions configured to oppose the first and second forward facing surface portions, respectively.

8. The lockable fiber optic connector assembly as set forth in claim 5, wherein the MPO connector has a fiber alignment axis perpendicular to the longitudinal axis and a transverse axis perpendicular to the fiber alignment axis and the longitudinal axis, wherein the wherein the inner housing comprises opposite first and second housing broad sides and opposite third and fourth latching sides, wherein the outer release sleeve comprises opposite first and second sleeve broad sides outboard of the first and second housing broad sides and opposite third and fourth latch covering sides outboard of the first and second latching sides, wherein the flange comprises a first flange portion and a second flange portion on opposite sides of the inner housing, wherein the forward facing surface comprises a first forward facing surface portion defined by the first flange portion and a second forward facing surface portion defined by the second flange portion, wherein the gap includes a first gap between the first forward facing surface portion and the first sleeve broad side and a second gap between the second forward facing surface portion and the second sleeve broad side, wherein the second sleeve broad side defines the rearward facing surface;
wherein the arm comprises first and second arms on opposite sides of the bracket and the finger comprises a first front finger protruding inward from the first arm and a second front finger protruding inward from the second arm, wherein the first front finger is configured to be received in the first gap and the second front finger is configured to be received in the second gap, wherein the first front finger is a snap finger defining a leading chamfer and wherein the second front finger is a locking finger defining the forward facing locking surface.

9. The lockable fiber optic connector assembly of claim 2, wherein the gap has a first length along the longitudinal axis and the front finger has a second length along the longitudinal axis that is from 80% to 100% of the first length.

10. The lockable fiber optic connector assembly of claim 1, wherein the MPO connector comprises a cable boot and the lock comprises a bracket configured to engage the cable boot when the lock is installed at the locking position.

11. The lockable fiber optic connector assembly of claim 10, wherein the lock further comprises an arm protruding forward from the bracket to a front finger protruding inward from the arm for reception between the forward facing surface and the rearward facing surface.

12. The lockable fiber optic connector assembly of claim 11, wherein the front finger defines the forward facing locking surface and the rear facing locking surface.

13. The lockable fiber optic connector assembly of claim 12, wherein the bracket defines a boot opening on an opposite side of the bracket from the arm and the bracket comprises first and second resilient bracket arms.

14. The lockable fiber optic connector assembly of claim 13, wherein the MPO connector has a fiber alignment axis and wherein the lock is configured to be installed by moving the lock toward the MPO connector along a transverse axis perpendicular to the fiber alignment axis and the longitudinal axis, whereby the front finger is received between the forward facing surface and the rearward facing surface, the cable boot passes through the boot opening and the first and second resilient bracket arms snap over and clip onto the cable boot.

15. The lockable fiber optic connector assembly of claim 1, wherein the lock comprises first and second lock portions configured to be fastened together to install the lock at the locking position.

16. The lockable fiber optic connector assembly of claim 15, wherein the MPO connector comprises a cable boot, wherein the first lock portion comprises a first bracket and the second lock portion comprises a second bracket, and wherein the first bracket and the second bracket comprise complementary fittings configured to fasten the first bracket to the second bracket around the cable boot to install the lock on the MPO connector.

17. The lockable fiber optic connector assembly of claim 16, wherein the flange comprises a first flange portion and a second flange portion on opposite sides of the inner housing, wherein the forward facing surface comprises a first forward facing surface portion defined by the first flange portion and a second forward facing surface portion defined by the second flange portion, wherein the rearward facing surface of the outer release sleeve comprises a first rearward facing surface portion opposing the first forward facing surface portion and a second rearward facing surface portion opposing the second rearward facing surface portion, wherein the first forward facing surface portion and the first rearward facing surface portion are in opposing spaced apart relation to define a first gap therebetween, and wherein the second forward facing surface portion and the second rearward facing surface portion are in opposing spaced apart relation to define a second gap therebetween;
wherein the first lock portion comprises a first arm protruding forward from the first bracket and a first front finger protruding inward from the first arm, the first front finger configured for being received in the first gap when the lock is installed at the locking position; and
wherein the second lock portion comprises a second arm protruding forward from the second bracket and a second front finger protruding inward from the second arm, the second front finger configured for being received in the second gap when the lock is installed at the locking position.

18. The lockable fiber optic connector assembly of claim 17, wherein the MPO connector has a fiber alignment axis and wherein the lock is configured to be installed by moving the first lock portion toward the second lock portion along a transverse axis perpendicular to the longitudinal axis and the fiber alignment axis to both (i) fasten the first bracket to the second bracket and (ii) load the first and second front fingers in the first and second gaps.

19. The lockable fiber optic connector assembly of claim 17, wherein the MPO connector has a fiber alignment axis and wherein the lock is configured to be installed by moving the first lock portion toward the second lock portion along the fiber alignment axis to both (i) fasten the first bracket to the second bracket and (ii) load the first and second front fingers in the first and second gaps.

20. The lockable fiber optic connector assembly of claim 1, wherein the MPO connector has a fiber alignment axis perpendicular to the longitudinal axis and a transverse axis perpendicular to the fiber alignment axis and the longitudinal axis, wherein the wherein the inner housing comprises opposite first and second housing broad sides and opposite third and fourth latching sides, wherein the outer release sleeve comprises opposite first and second sleeve broad sides outboard of the first and second housing broad sides and opposite third and fourth latch covering sides outboard of the first and second latching sides, wherein the first housing broad side and the first sleeve broad side define an interface opening therebetween extending along the fiber alignment axis from the first housing broad side to the first sleeve broad side, wherein the first sleeve broad side defines the rearward facing surface of the release sleeve, wherein the flange is formed on the first housing broad side, wherein the forward facing surface of the flange and the rearward facing surface of the first sleeve broad side are in opposing spaced apart relation to define a gap therebetween, the gap extending along the longitudinal axis from the rearward facing surface to the forward facing surface.

21. The lockable fiber optic connector assembly of claim 20, wherein the lock comprises a lock insert comprising a base and a finger upstanding from the base, the base comprising a toe forward of the finger, the lock insert configured to be fitted between the outer release sleeve and the inner housing when the lock is in the locking position such that the base is supported on the first housing broad side, the toe is received in the interface opening and the finger is received in the gap.

22. The lockable fiber optic connector assembly of claim 1, wherein when the forward facing locking surface is rearward of the rearward facing locking surface.

23. The lockable fiber optic connector assembly of claim 22, wherein the MPO connector further comprises a push-pull boot and wherein the outer release sleeve comprises attachment ears operably coupled to the push-pull boot, the attachment ears defining the rearward facing surface. 24 The lockable fiber optic connector assembly of claim 23, wherein the lock comprises a bracket configured to straddle the push-pull boot, the bracket defining a cable opening, the bracket having a front end portion defining the forward facing locking surface, the lock further comprising an arm protruding forward from the bracket to and a front finger protruding inward from the arm, the front finger defining a leading chamfer,
wherein the lock is configured to be installed on the MPO connector by passing a cable terminated by the MPO connector through the cable opening into the bracket and then advancing the lock forward along the longitudinal axis until the front finger snaps over the flange.

25. The lockable fiber optic connector assembly of claim 1, wherein the MPO connector comprises first and second MPO connectors and the lock is a single-piece lock.

26. A method of making a secure optical connection, the method comprising:
plugging an MPO connector into an MPO adapter; and
after plugging the MPO connector into the MPO adapter, installing a lock on the MPO connector so that the lock simultaneously opposes a rearward facing surface of an outer release sleeve and a forward facing surface on an inner housing to prevent extraction of the MPO connector from the MPO adapter by rearward displacement of the outer release sleeve in relation to the inner housing.
